(19) United States
(12) Patent Application Publication
(10) Pub. No.: US 2024/0381378 A1
(43) Pub. Date: Nov. 14, 2024

(54) METHOD AND APPARATUS FOR ALLOCATING SL-PRS TRANSMISSION RESOURCES IN SIDELINK POSITIONING IN WIRELESS COMMUNICATION SYSTEM

(71) Applicant: Samsung Electronics Co., Ltd., Suwon-si (KR)

(72) Inventors: Taeseop LEE, Suwon-si (KR); Hyunjeong KANG, Suwon-si (KR); Jeongseok YU, Suwon-si (KR)

(21) Appl. No.: 18/660,817

(22) Filed: May 10, 2024

(30) Foreign Application Priority Data
May 11, 2023 (KR) 10-2023-0061269

(51) Int. Cl. H04W 72/25; H04W 72/232

(52) U.S. Cl. CPC H04W 72/25; H04W 72/232

(57) ABSTRACT

A method performed by a user equipment (UE) in a wireless communication system is provided. The method includes transmitting, to a base station, sidelink UE information associated with the UE, wherein the sidelink UE information includes information for requesting a configuration of a resource for a sidelink positioning reference signal (SL-PRS), receiving, from the base station, configuration information associated with a resource pool for the SL-PRS, transmitting, to the base station, information for requesting a SL-PRS resource, based on the configuration information, receiving, from the base station, first downlink control information (DCI) scheduling the SL-PRS resource, and transmitting the SL-PRS on the SL-PRS resource based on the first DCI.

### CROSS-REFERENCE TO RELATED APPLICATION(S)

This application is based on and claims priority under 35 U.S.C. § 119(a) of a Korean patent application number 10-2023-0061269, filed on May 11, 2023, in the Korean Intellectual Property Office, the disclosure of which is incorporated by reference herein in its entirety.

### BACKGROUND

### 1. Field

The disclosure relates to sidelink positioning in a mobile communication system. More particularly, the disclosure relates to a method and an apparatus for allocating SL-PRS transmission resources in sidelink positioning.

### 2. Description of Related Art

Fifth generation (5G) mobile communication technology defines a wide frequency band to enable fast transmission speeds and new services, and includes sub-6 gigahertz (GHz) (‘Sub 6 GHz’) bands such as 3.5 gigahertz (3.5 GHz) as well as millimeter wave (mm) bands such as 28 GHz and 39 GHz. It is also possible to implement it in the ultra-high frequency band (‘Above 6 GHz’) called Wave. In addition, in the case of sixth generation (6G) mobile communication technology, which is called the system of beyond 5G communication, Implementation in the Terahertz (THz) band (e.g., 95 GHz to 3 terahertz bands) is being considered to achieve a transmission speed that is 50 times faster than 5G mobile communication technology and an ultra-low delay time that is reduced to one-tenth.

In the early days of 5G mobile communication technology, there were concerns about ultra-wideband services (enhanced Mobile BroadBand, eMBB), ultra-reliable low-latency communications (URLLC), and massive machine-type communications (mMTC), with the goal of satisfying service support and performance requirements, Beamforming and massive multiple-input multiple-output (MIMO) to alleviate radio wave path loss in the ultra-high frequency band and increase the transmission distance of radio waves, and various numerology support (multiple subs) for efficient use of ultra-high frequency resources carrier interval operation, etc.) and dynamic operation of slot format, initial access technology to support multi-beam transmission and broadband, definition and operation of Band-Width Part (BWP), and Low Density Parity Check (LDPC) for large data transmission. New channel coding methods such as Polar Code for highly reliable transmission of codes and control information, L2 pre-processing, and Network Slicing to provide a dedicated network specialized for specific services. Standardization has progressed.

Currently, discussions are underway to improve and enhance the initial 5G mobile communication technology, considering the services that 5G mobile communication technology was intended to support, based on the vehicle's own location and status information. Vehicle-to-Everything (V2X) to help autonomous vehicles make driving decisions and increase user convenience, and New Radio Unlicensed (NR-U), which aims to operate a system that meets various regulatory requirements in unlicensed bands, new radio (NR) terminal low power consumption technology (user equipment (UE) Power Saving), Non-Terrestrial Network (NTN), which is direct terminal-satellite communication to secure coverage in areas where communication with the terrestrial network is impossible, positioning, etc. Physical (PHY) layer standardization for technology is in progress.

In addition, integrated access and backhaul (IAB) provides a node for expanding the network service area by integrating intelligent factories (Industrial Internet of Things (IIoT)) to support new services through linkage and convergence with other industries, and wireless backhaul links and access links. Integrated Access and Backhaul, Mobility Enhancement including Conditional Handover and Dual Active Protocol Stack (DAPS) handover, and 2-step Random Access (2-step random access channel (RACH) for simplification of random access procedures) Standardization in the field of wireless interface architecture/protocol for technologies such as NR) is also in progress, and a 5G baseline for incorporating Network Functions Virtualization (NFV) and Software-Defined Networking (SDN) technology Standardization in the field of system architecture/services for architecture (e.g., Service based Architecture, Service based Interface) and Mobile Edge Computing (MEC), which provides services based on the location of the terminal, is also in progress.

When this 5G mobile communication system is commercialized, an explosive increase in connected devices will be connected to the communication network. Accordingly, it is expected that strengthening the functions and performance of the 5G mobile communication system and integrated operation of connected devices will be necessary. To this end, eXtended Reality (XR) and Artificial Intelligence to efficiently support Augmented Reality (AR), Virtual Reality (VR), and Mixed Reality (MR), Artificial Intelligence (AI) and machine learning (ML), new research will be conducted on 5G performance improvement and complexity reduction, AI service support, metaverse service support, and drone communication.

In addition, the development of these 5G mobile communication systems includes new waveforms, full dimensional multiple input/output (FD-MIMO), and array antennas to ensure coverage in the terahertz band of 6G mobile communication technology, multi-antenna transmission technology such as Large Scale Antenna, metamaterial-based lens and antenna to improve coverage of terahertz band signals, high-dimensional spatial multiplexing technology using Orbital Angular Momentum (OAM), In addition to Reconfigurable Intelligent Surface technology (RIS), Full Duplex technology, satellite, and Artificial Intelligence (AI) to improve the frequency efficiency of 6G mobile communication technology and system network are utilized from the design stage and end-to-end. Development of AI-based communication technology that realizes system optimization by internalizing AI support functions, and next-generation distributed computing technology that realizes services of complexity beyond the limits of terminal computing capabilities by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for effectively providing a service in a next-generation wireless communication system.

In accordance with an aspect of the disclosure, a method performed by a user equipment (UE) in a wireless communication system is provided. The method includes transmitting, to a base station, sidelink UE information associated with the UE, wherein the sidelink UE information includes information for requesting a configuration of a resource for a sidelink positioning reference signal (SL-PRS), receiving, from the base station, configuration information associated with a resource pool for the SL-PRS, transmitting, to the base station, information for requesting a SL-PRS resource, based on the configuration information, receiving, from the base station, first downlink control information (DCI) scheduling the SL-PRS resource, and transmitting the SL-PRS on the SL-PRS resource based on the first DCI.

In accordance with an aspect of the disclosure, a method performed by a base station in a wireless communication system is provided. The methods includes receiving, from a user equipment (UE), sidelink UE information associated with the UE, wherein the sidelink UE information includes information for requesting a configuration of a resource for a sidelink positioning reference signal (SL-PRS), transmitting, to the UE, configuration information associated with a resource pool for the SL-PRS, receiving, from the UE, information for requesting a SL-PRS resource, based on the configuration information, and transmitting, to the UE, first downlink control information (DCI) scheduling the SL-PRS resource, wherein the SL-PRS is transmitted on the SL-PRS resource based on the first DCI.

In accordance with an aspect of the disclosure, a user equipment (UE) in a wireless communication system is provided. The UE includes a transceiver, a controller coupled to the transceiver and configured to: transmit, to a base station, sidelink UE information associated with the UE, wherein the sidelink UE information includes information for requesting a configuration of a resource for a sidelink positioning reference signal (SL-PRS), receive, from the base station, configuration information associated with a resource pool for the SL-PRS, transmit, to the base station, information for requesting a SL-PRS resource, based on the configuration information, receive, from the base station, first downlink control information (DCI) scheduling the SL-PRS resource; and transmit the SL-PRS on the SL-PRS resource based on the first DCI.

In accordance with an aspect of the disclosure, a base station in a wireless communication system is provided. The base station includes a transceiver, and a controller coupled with the transceiver and configured to: receive, from a user equipment (UE), sidelink UE information associated with the UE, wherein the sidelink UE information includes information for requesting a configuration of a resource for a sidelink positioning reference signal (SL-PRS), transmit, to the UE, configuration information associated with a resource pool for the SL-PRS, receive, from the UE, information for requesting a SL-PRS resource, based on the configuration information; and transmit, to the UE, first downlink control information (DCI) scheduling the SL-PRS resource, wherein the SL-PRS is transmitted on the SL-PRS resource based on the first DCI.

Additional aspects will be set forth in part in the description which follows and, in part, will be apparent from the description, or may be learned by practice of the presented embodiments.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of an NR system according to an embodiment of the disclosure;

FIG. 2 illustrates wireless protocol structures in long term evolution (LTE) and NR systems according to an embodiment of the disclosure;

FIG. 3 illustrates a network structure for providing a UE location estimation service (location services (LCS)) according to an embodiment of the disclosure;

FIG. 4 illustrates a sidelink positioning (hereinafter, referred to as SL-P) service scenario according to an embodiment of the disclosure;

FIG. 5 illustrates an example of signal flow for allocating sidelink transmission resources in a wireless communication system according to an embodiment of the disclosure;

FIG. 6 illustrates the existing sidelink data transmission resource structure and an SL-PRS transmission resource structure according to an embodiment of the disclosure;

FIG. 7 illustrates an example of signal flow for allocating sidelink positioning reference signal (SL-PRS) transmission resources in a dynamic grant scheme according to an embodiment of the disclosure;

FIG. 8 illustrates an example of medium access control (MAC) control element (CE) formats used when SL-PRS transmission resources are allocated in a dynamic grant scheme according to an embodiment of the disclosure;

FIG. 9 illustrates an example of signal flow for allocating periodic SL-PRS transmission resources according to an embodiment of the disclosure;

FIG. 10 illustrates an example of a MAC CE format used when periodic SL-PRS transmission resources are allocated according to an embodiment of the disclosure;

FIG. 11 illustrates a UE apparatus according to an embodiment of the disclosure; and

FIG. 12 illustrates a gNodeB (gNB) apparatus according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

At this time, it will be understood that each block of the processing flow diagrams and combinations of the flow diagram diagrams can be performed by computer program instructions. These computer program instructions can be mounted on a processor of a general-purpose computer, special-purpose computer, or other programmable data processing equipment, so that the instructions performed through the processor of the computer or other programmable data processing equipment are described in the flow chart block(s). It creates the means to perform functions. These computer program instructions may also be stored in computer-usable or computer-readable memory that can be directed to a computer or other programmable data processing equipment to implement a function in a particular manner, so that the computer-usable or computer-readable memory The instructions stored in are also capable of producing manufactured items containing instruction means that perform the functions described in the flow diagram block(s). Computer program instructions can also be mounted on a computer or other programmable data processing equipment, so that a series of operational steps are performed on the computer or other programmable data processing equipment to create a process that is executed by the computer, thereby generating a process that is executed by the computer or other programmable data processing equipment. Instructions that perform processing equipment may also provide steps for executing the functions described in the flow diagram block(s).

Additionally, each block may represent a module, segment, or portion of code that includes one or more executable instructions for executing specified logical function(s). Additionally, it should be noted that in some alternative execution examples, it is possible for the functions mentioned in the blocks to occur out of order. For example, it is possible for two blocks shown in succession to be performed substantially simultaneously, or it is possible for the blocks to be performed in reverse order depending on the corresponding function.

At this time, the term ‘˜unit’ used in this embodiment refers to software or hardware components such as Field Programmable Gate Array (FPGA) or Application Specific Integrated Circuit (ASIC), and ‘˜unit’ performs certain roles. do. However, ‘˜part’ is not limited to software or hardware. The ‘˜part’ may be configured to reside in an addressable storage medium and may be configured to reproduce on one or more processors. Therefore, as an example, ‘˜part’ refers to components such as software components, object-oriented software components, class components, and task components, processes, functions, properties, and procedures, subroutines, segments of program code, drivers, firmware, microcode, circuitry, data, databases, data structures, tables, arrays, and variables. The functions provided within the components and ‘parts’ may be combined into a smaller number of components and ‘parts’ or may be further separated into additional components and ‘parts’. In addition, the components and ‘parts’ may be implemented to regenerate one or more central processing units (CPUs) within the device or secure multimedia card. Additionally, in an embodiment, ‘˜ part’ may include one or more processors.

In the following description of the disclosure, if a detailed description of a related known function or configuration is determined to unnecessarily obscure the gist of the disclosure, the detailed description will be omitted. Hereinafter, embodiments of the disclosure will be described with reference to the attached drawings.

Terms used in the following description to identify a connection node, terms referring to network entities, terms referring to messages, terms referring to interfaces between network objects, and various identification information. Referring terms, etc. are exemplified for convenience of explanation. Accordingly, the disclosure is not limited to the terms described below, and other terms referring to objects having equivalent technical meaning may be used.

In the following description, physical channel and signal may be used interchangeably with data or control signals. For example, physical downlink shared channel (PDSCH) is a term that refers to a physical channel through which data is transmitted, but PDSCH can also be used to refer to data. That is, in the disclosure, the expression ‘transmit a physical channel’ can be interpreted equivalently to the expression ‘transmit data or a signal through a physical channel’.

Hereinafter, in the disclosure, higher signaling refers to a method of transmitting a signal from a base station to a terminal using a downlink data channel of the physical layer, or from a terminal to a base station using an uplink data channel of the physical layer. High-level signaling can be understood as radio resource control (RRC) signaling or media access control (MAC) control element (CE).

For convenience of description below, the disclosure uses terms and names defined in the 3rd Generation Partnership Project New Radio (NR) (3GPP NR) or 3rd Generation Partnership Project Long Term Evolution (3GPP LTE) specifications. However, the disclosure is not limited by the above terms and names, and can be equally applied to systems complying with other standards. In this disclosure, gNB may be used interchangeably with eNode B (eNB) for convenience of explanation. That is, a base station described as an eNB may represent a gNB. Additionally, the term terminal can refer to mobile phones, MTC devices, NB-IoT devices, sensors, as well as other wireless communication devices.

Hereinafter, the base station is the entity that performs resource allocation for the terminal, and may be at least one of gNodeB (gNB), eNode B (eNB), NodeB, Base Station (BS), wireless access unit, base station controller, or node on the network. A terminal may include a User Equipment (UE), Mobile Station (MS), a cellular phone, a smartphone, a computer, or a multimedia system capable of performing communication functions. Of course, it is not limited to the above example.

The disclosure relates to a method and device for performing sidelink (hereinafter referred to as SL) positioning in a mobile communication system. More specifically, the disclosure relates to a method and device for a terminal within a base station communication range to perform sidelink positioning (hereinafter referred to as SL-P) in 3GPP 5G system (5GS).

Terms used in the disclosure may be defined as follows.
Sidelink positioning (hereinafter, referred to SL-P): estimates a location of a user equipment (UE) using a reference signal (referred to as an SL-PRS to make the following description easy) transmitted in an SL. At this time, the location of the UE may be indicated by absolute location information (absolute position), relative location information (relative position), ranging location (for example, information on distance/direction from another UE), and the like. Ranging operation (estimating distance/direction/relatively location between UEs) may be included in an SL-P process.
Target UE: a UE of which a location is to estimated.
Anchor UE: a UE assisting in estimating the location of the target UE (for example, a UE transmitting and receiving a reference signal to estimate the location of the target UE, a UE transferring information required for estimating the location to the target UE through the SL, or the like).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

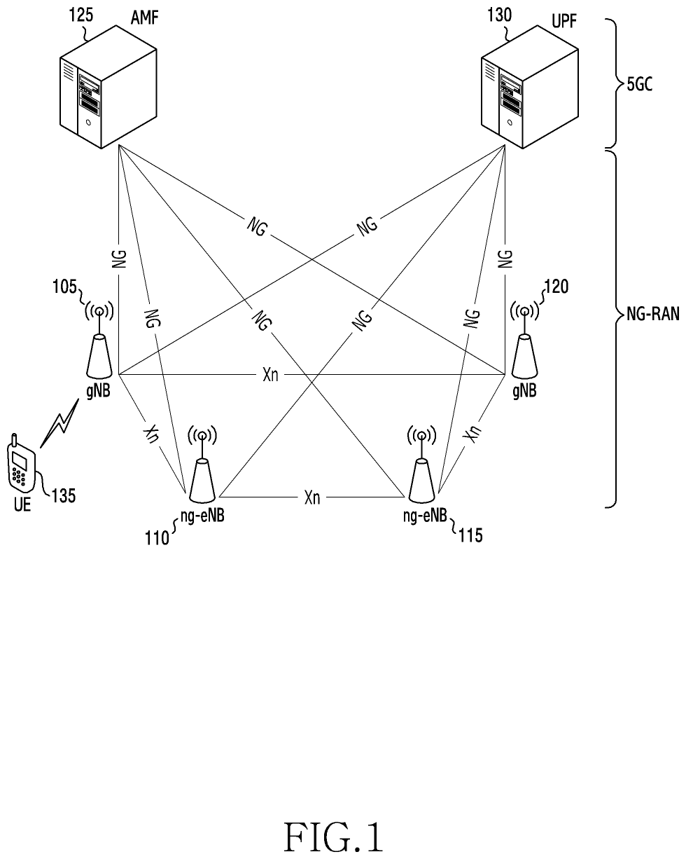

FIG. 1 illustrates a structure of an NR system according to an embodiment of the disclosure.

Referring to FIG. 1, a wireless communication system may include a plurality of base stations (for example, a gNB 105, an ng-eNB 110, an ng-eNB 115, and a gNB 120), an access and mobility management function (AMF) 125, and a user plane function (UPF) 130. A user equipment 135 (UE or terminal) may access an external network through the base stations (for example, the gNB 105, the ng-eNB 110, the ng-eNB 115, and the gNB 120) and the UPF 130.

In FIG. 1, the base stations (for example, the gNB 105, the ng-eNB 110, the ng-eNB 115, and the gNB 120) may provide radio access to UEs accessing the network as access nodes of the cellular network. That is, the base stations (for example, the gNB 105, the ng-eNB 110, the ng-eNB 115, and the gNB 120) may collect and schedule status information of buffer statuses of UEs, available transmission power statuses, channel statuses, and the like to serve traffic of users and support the connection between the UEs and a core network (CN; particularly, a CN of NR is referred to as a 5G core (5GC)). Meanwhile, in communication, a user plane (UP) related to transmission of real user data and a control plane (CP) such as connection management may be separately configured. In FIG. 1, the gNB 105 and the gNB 120 may use UP and CP technology defined in NR technology, and the ng-eNB 110 and the ng-eNB 115 are connected to the 5GC but may use UP and CP technology defined in LTE technology.

The AMF 125 is a device that performs various control functions as well as a function of managing mobility of the UE and is connected to a plurality of base stations, and the UPF 130 may be a kind of gateway device that provides data transmission. Although not illustrated in FIG. 1, the NR wireless communication system may include a session management function (SMF). The SMF may manage a packet data network connection such as a protocol data unit (PDU) session.

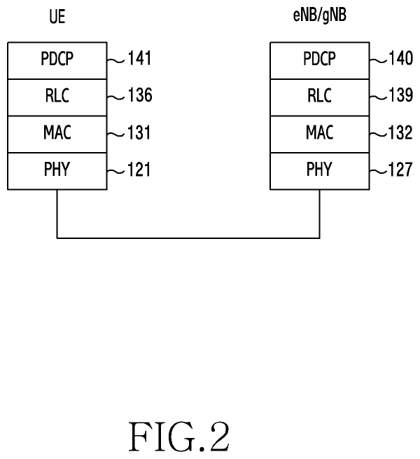

FIG. 2 illustrates wireless protocol structures in LTE and NR systems according to an embodiment of the disclosure.

Referring to FIG. 2, the UE and the eNB includes packet data convergence protocols (PDCPs) 141 and 140, radio link controls (RLCs) 136 and 139, medium access controls (MACs) 131 and 132, respectively, in the wireless protocol of the LTE system. The packet data convergence protocols (PDCPs) 141 and 140 perform an operation of compressing/reconstructing an IP header, and the radio link controls (RLCs) 136 and 139 reconfigure a PDCP packet data unit (PDU) to have a proper size. The MACs 131 and 132 are connected with various RLC layer devices included in one UE, and perform an operation for multiplexing RLC PDUs to the MAC PDU and de-multiplexing the RLC PDUs from the MAC PDU. The PHY layers 121 and 127 perform an operation for channel-coding and modulating higher layer data to generate an orthogonal frequency division multiplexing (OFDM) symbol and transmitting the OFDM symbol through a radio channel or demodulating and channel-decoding the OFDM symbol received through the radio channel and transmitting the demodulated and channel-decoded OFDM symbol to the higher layer. Further, for additional error correction, the physical layer may use hybrid automatic repeat request (HARQ), and a receiving side transmits one bit in order to indicate whether a packet transmitted from a transmitting side has been received. This is referred to as HARQ acknowledgment (ACK)/negative acknowledgment (NACK) information. Downlink HARQ ACK/NACK information for uplink data transmission may be transmitted through a physical hybrid-ARQ indicator channel (PHICH) in the case of LTE, and it is determined whether retransmission of the downlink HARQ ACK/NACK information through scheduling information of the corresponding UE is needed in a physical dedicated control channel (PDCCH) that is a channel in which downlink/uplink resource allocation is performed or new transmission should be performed in the case of NR. This is because non-synchronous HARQ is applied to NR. Uplink HARQ ACK/HARQ information for downlink transmission may be transmitted through a physical channel such as a physical uplink control channel (PUCCH) or a physical uplink shared channel (PUSCH). In general, the PUCCH is transmitted in uplink of a PCell described below, but, if the UE supports it, the eNB may additionally transmit the PUCCH to the UE in an secondary cell (SCell) described below, which is referred to as a PUCCH SCell.

Although not illustrated in FIG. 2, there is a radio resource control (RRC) layer above the PDCP layer of each of the UE and the eNB, and the RRC layer may transmit and receive an access- and measurement-related configuration control message to control radio resources.

Meanwhile, the PHY layer may include one or a plurality of frequencies/carriers. Technology that simultaneously configures and uses a plurality of frequencies is referred to as carrier aggregation (CA). The CA significantly increases the amount of transmission by the number of subcarriers by additionally using a primary carrier and one or a plurality of subcarriers, which is beyond the conventional technology, in which only one carrier is used for communication between the UE and the eNB (E-UTRAN NodeB). Meanwhile, in LTE, a cell within the eNB using a primary carrier is referred to as a primary cell (PCell) and a cell within the eNB using a subcarrier is referred to as a secondary cell (SCell).

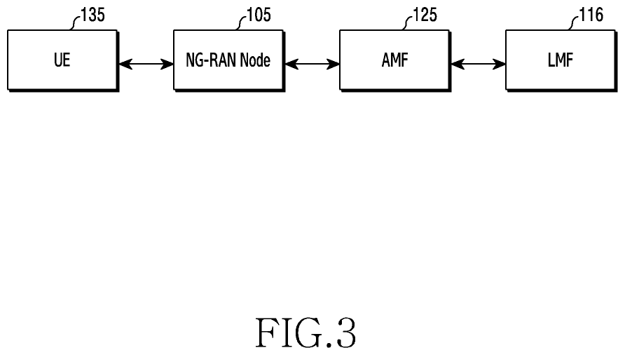

FIG. 3 illustrates a network structure for providing a UE location estimation service (location services (LCS)) according to an embodiment of the disclosure.

Referring to FIG. 3, in a mobile communication system, a network for providing an LCS includes a UE 135, an NG-RAN Node 105, an access and mobility function (AMF) 125, and a location management function (LMF) 116. At this time, the UE 135 communicates with the LMF 116 through the NG-RAN Node 105 and the AMF 125 and exchanges information required for location estimation. The role of each element for providing the LCS is described below.

The UE 135 may serve to measure a radio signal required for location estimation and transfer the result to the LMF 116.

The NG-RAN Node 105 may serve to transmit a downlink radio signal required for location estimation and measure an uplink radio signal transmitted by a target UE.

The AMF 125 may serve to receive an LCS request message from an LCS requester, transfer the LCS request message to the LMF 116, and indicate provision of the location provision service. When the LMF 116 processes the location estimation request and then transmits the estimation result of the location of the UE, the AMF 125 may transfer the corresponding result to the LCS requester.

The LMF 116 is a device that receives the LCS request from the AMF 125 and processes the LCS request and may serve to control the overall process required for location estimation. In order to estimate the location of the UE, the LMF 116 may provide auxiliary information required for location estimation and signal measurement to the UE 135 and receive result values thereof. At this time, an LTE positioning protocol (LPP) may be used as a protocol for data exchange. The LPP may define specifications of message exchanged between the UE 135 and the LMF 116 for the location estimation service. Further, the LMF 116 may exchange downlink reference signal (positioning reference signal (PRS) configuration information to be used for location estimation and an uplink reference signal (sounding reference signal (SRS) measurement result with the NG-RAN Node 105. At this time, an NR positioning protocol A (NRPPa) may be used as the protocol for data exchange, and the NRPPa may define specifications of message exchanged between the NG-RAN Node 105 and the LMF 116.

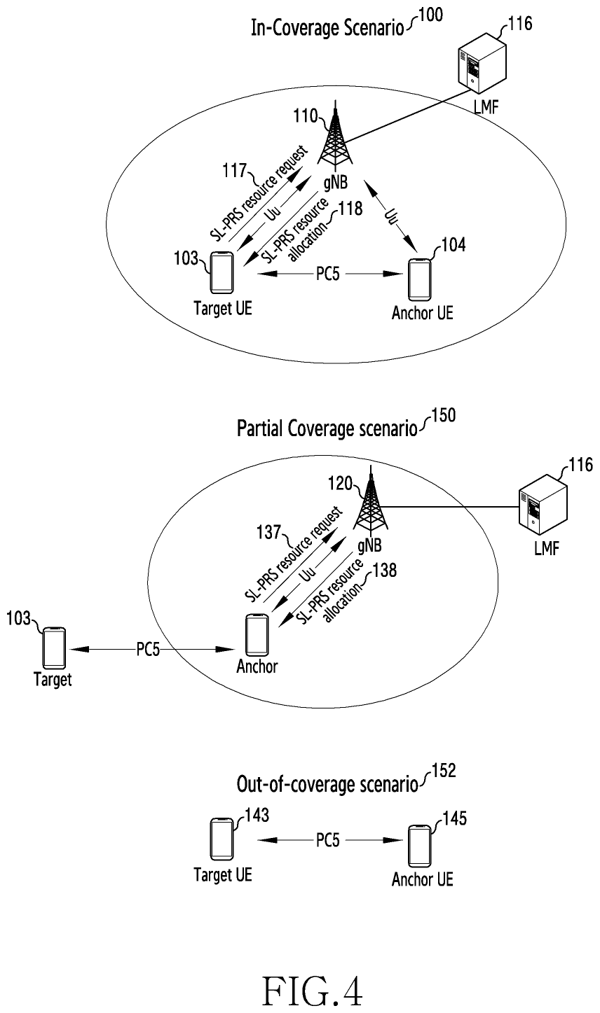

FIG. 4 illustrates a sidelink positioning (hereinafter, referred to as SL-P) service scenario according to an embodiment of the disclosure.

Referring to FIG. 4, there SL-P scenarios below may be defined according to whether a target/anchor UE is within each base station communication range (that is, cell coverage of the gNB).
In-Coverage scenario 100: a scenario in which a target UE 103 of which a location is to be estimated in SL-P and an anchor UE 104 helping in location estimation are all within a communication range of a gNB 110. At this time, the target/anchor UE is connected to a cell operated by the gNB 110 and can communicate through a UU interface. The LMF 116 may exchange LPP messages with the target UE/anchor UE 103/104 for the SL-P operation and involve in the SL-P operation. LPP messages between the LMF 116 and the target/anchor UE are transmitted and received through the UU interface with the gNB 110.

For the SL-P operation, the target UE 103 may transmit and receive the SL-PRS to and from the anchor UE 104 through a PC5 interface. Further, the target UE 103 and the anchor UE 104 may exchange control messages (for example, sidelink positioning protocol (SLPP) messages) for transmitting and receiving the SL-PRS and performing SL-P through the PC5 interface. A mode 1 or mode 2 scheme may be used as a method of configuring resources for sidelink (hereinafter, referred to as SL) transmission of the target UE/anchor UE 103/104.

In the case of the mode 1 scheme, the gNB 110 may directly allocate SL transmission resources for the SL-P operation. At this time, the SL transmission resources may be allocated from licensed band carriers used only for SL communication (licensed carriers dedicated to SL communication) or licensed band carriers used for SL and uplink transmission (licensed carriers sharing resources between SL and UL communication). When the mode 1 resource configuration scheme is used, the target UE/anchor UE 103/104 receiving an indication of SL-P-related transmission (for example, SL-PRS transmission) through LPP signaling with the LMF 116 or SLPP signaling with another UE may directly make a request for SL transmission resources required for the corresponding transmission to the gNB 110 in operation 117. In this case, the gNB 110 may allocate the required SL transmission resources according to the UE request in operation 118.

When the mode 2 scheme is used, the gNB 110 may allocate sidelink resource pools that can be used for SL transmission, and the target/anchor UE 103/104 may directly select transmission resources required for the SL-P operation.

In the mode 1 and mode 2 resource configuration, a shared resource pool or a dedicated resource pool may be configured as the SL resource pool for the SL-P operation. The use of the shared SL resource pool means that a resource pool configured for SL communication is used for transmitting SL-P-related information. The use of the dedicated SL resource pool means that a resource pool individually configured for the SL-P function is used for transmitting SL-P-related information.
Partial coverage scenario 150: a scenario in which the target UE 103 of which the location is to be estimated in SL-P is located outside the communication range of the gNB 120 and the anchor UE 104 helping in location estimation is within the communication range of the gNB 120. At this time, the anchor UE 104 is connected to a cell operated by the gNB and can communicate through a UU interface. The target UE 103 can communicate with the anchor UE 104 through an SL PC5 interface. At this time, the LMF 116 may exchange LPP messages with the target UE/anchor UE 103/104 for the SL-P operation and involve in the SL-P operation. LPP message between the LMF 116 and the anchor UE 104 may be transmitted and received through the UU interface with the gNB 120, and LPP messages between the LMF 116 and the target UE 103 may be exchanged by the SL relay operation of the anchor UE 104. For example, LPP messages which the target UE 103 transmits to the LMF 116 may be transferred to the anchor UE 104 through the PC5 interface and then transferred to the network through the UU interface of the anchor UE 104.

For the SL-P operation, the target UE 103 may transmit and receive the SL-PRS to and from the anchor UE 104 through a PC5 interface. Further, the target UE 103 and the anchor UE 104 may exchange control messages for transmitting and receiving the SL-PRS and performing SL-P through the PC5 interface. The mode 1 or mode 2 scheme may be used as a method of configuring resources for sidelink (hereinafter, referred to as SL) transmission of the target UE 103/anchor UE104.

In the case of the mode 1 scheme, the base station 120 may directly allocate SL transmission resources for the SL-P operation. At this time, the SL transmission resources may be allocated from licensed band carriers used only for SL communication (licensed carriers dedicated to SL communication) or licensed band carriers used for SL and uplink transmission (licensed carriers sharing resources between SL and UL communication). When the mode 1 resource configuration scheme is used, the target UE/anchor UE 103/104 receiving an indication of SL-P-related transmission (for example, SL-PRS transmission) through LPP signaling with the LMF 116 or SLPP signaling with another UE may directly make a request for SL transmission resources required for the corresponding transmission to the gNB in operation 137. In this case, the base station 120 may allocate the required SL transmission resources according to the UE request in operation 138.

When the mode 2 scheme is used, the gNB 120 may allocate sidelink resource pools that can be used for SL transmission, and the target/anchor UE 103/104 may directly select transmission resources required for the SL-P operation.

In the mode 1 and mode 2 resource configuration, a shared resource pool or a dedicated resource pool may be configured as the SL resource pool for the SL-P operation. The use of the shared SL resource pool may mean that a resource pool configured for SL communication is used for transmitting SL-P-related information. The use of the dedicated SL resource pool means that the pool individually configured for the SL-P function is used for transmitting SL-P-related information.
Out-of-coverage scenario 152: a scenario in which the target UE 143 and the anchor UE 145 of which the location is to be estimated in SL-P are all located outside the gNB communication range. At this time, all of the target UE/anchor UE 143/145 cannot communicate with the gNB through the UU interface, and the target UE 143 can communicate with the anchor UE 145 only through the SL PC5 interface. At this time, the LMF cannot exchange LPP messages with the target UE/anchor UE 143/145 for the SL-P operation and, accordingly, cannot be directly involved in the SL-P operation. For the SL-P operation, the target UE 143 may transmit and receive the SL-PRS to and from the anchor UE 145 through a PC5 interface. Further, the target UE 143 and the anchor UE 145 may exchange control messages for transmitting and receiving the SL-PRS and performing SL-P through the PC5 interface. The mode 2 scheme may be used as a method of configuring resources for sidelink (hereinafter, referred to as SL) transmission of the target UE/anchor UE 143/145.

When the mode 2 scheme is used, the gNB may allocate in advance a resource pool (sidelink resource pool) that can be used for SL transmission (for example, the allocation can be configured inside the gNB communication range), and the target UE/anchor UE 143/145 may directly select transmission resources required for SL-P operation. The shared resource pool or the dedicated resource pool may be configured as the SL resource pool for the SL-P operation. The use of the shared SL resource pool may mean that a resource pool configured for SL communication is used for transmitting SL-P-related information. The use of the dedicated SL resource pool means that the pool individually configured for the SL-P function is used for transmitting SL-P-related information.

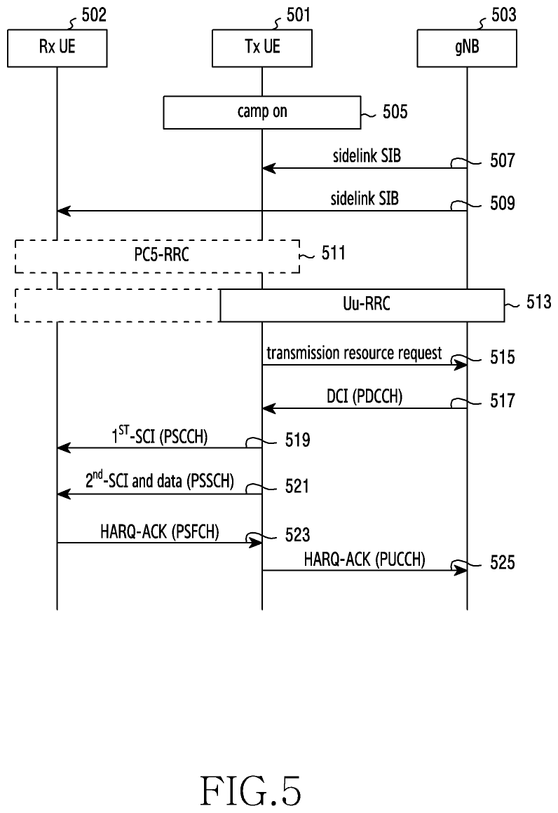

FIG. 5 illustrates an example of signal flow for allocating sidelink transmission resources in a wireless communication system according to an embodiment of the disclosure.

Referring to FIG. 5, signal exchange between a transmission UE 501, a reception UE 502, and a gNB 503 is illustrated.

As described below, a method by which the gNB allocates transmission resources for sidelink communication may be referred to as mode 1. Mode 1 is a scheme based on scheduled resource allocation by the gNB. More specifically, in mode 1 resource allocation, the gNB may allocate resources used for sidelink transmission to RRC-connected UEs according to a dedicated scheduling scheme. Since the gNB can manage sidelink resources, scheduled resource allocation is advantageous in managing interference and a resource pool (for example, dynamic allocation and/or semi-persistent transmission).

Referring to FIG. 5, in operation 507, the transmission UE 501 which camps on a cell in operation 505 may receive a sidelink system information block (SIB) from the gNB 503. In operation 509, the reception UE 502 may receive the sidelink SIB from the gNB 503. The reception UE 502 is a UE which receives data transmitted by the transmission UE 501. The sidelink SIB may be transmitted periodically or according to a request (on demand). Further, the sidelink SIB may include at least one piece of sidelink resource pool information for sidelink communication, parameter configuration information for a sensing operation, information for configuring sidelink synchronization, or carrier information for sidelink communication operating in different frequencies. Although operations 507 and 509 have been sequentially described, it is only for convenience of description, and operations 507 and 509 may be performed in parallel.

When data traffic for sidelink communication is generated by the transmission UE 501, the transmission UE 501 may make an RRC connection with the gNB 503 in operation 513. The RRC connection between the transmission UE 501 and the gNB 503 may be referred to as Uu-RRC. The Uu-RRC connection may be made before the data traffic of the transmission UE 501 is generated. Further, in the case of mode 1, the transmission UE 501 may perform transmission to the reception UE 502 through the sidelink in the state where the Uu-RRC connection is made between the gNB 503 and the reception UE 502. In addition, in the case of mode 1, the transmission UE 501 may perform transmission to the reception UE 502 through the sidelink even in the state where the Uu-RRC connection is not made between the gNB 503 and the reception UE 502.

In operation 515, the transmission UE 501 may make a request for transmission resources for performing sidelink communication with the reception UE 502 to the gNB 503. At this time, the transmission UE 501 may make a request for transmission resources for the sidelink by using at least one of an uplink physical control channel (physical uplink control channel (PUCCH), an RRC message, or a MAC CE. For example, when the MAC CE is used, the MAC CE may be a MAC CE about a buffer status report having a new format including at least one of an indicator indicating a buffer status report (BSR) for sidelink communication and information on the size of data stored in the buffer for device-to-device (D2D) communication (or V2X communication). The MAC CE may be called a sidelink BSR MAC CE. Further, when the PUCCH is used, the transmission UE 501 may make a request for sidelink resources through a bit of a scheduling request (SR) transmitted through an uplink physical control channel. Further, when the RRC is used, the transmission UE 501 may transfer frequencies for transmission and reception of various types of sidelink communication including sidelink discovery, sidelink data communication, and sidelink relay communication and information on the reception UE 502 to the gNB through Uu-RRC, which may include at least one piece of the following information through the same or different RRC messages.
Frequency to use reception in sidelink communication
Frequency to use transmission in sidelink communication
Type of sidelink data transmitted in sidelink communication
Period and size of sidelink data transmitted in sidelink communication
Information on target UE receiving sidelink data transmitted in sidelink communication (ID of target UE, UE capability, discontinuous reception (DRX) information, and the like)
QoS information of sidelink data transmitted in sidelink communication
Cast type of sidelink data transmitted in sidelink communication
RLC mode of sidelink data transmitted in sidelink communication

In operation 515, the PUCCH, the MAC CE, and the RRC message may be independently used or may be used together according to the purpose. Further, although operation 513 is described after operation 515, it is only for convenience of description, and may be used for a request for resources for establishing PC5-RRC 511 between the transmission UE 501 and the reception UE 502 and performed in parallel or simultaneously with other operations.

In operation 517, the gNB 503 may transmit downlink control information (DCI) to the transmission UE 501 through a PDCCH. That is, the gNB 503 may indicate final scheduling for sidelink communication with the reception UE 502 to the transmission UE 501. More specifically, the gNB 503 may allocate sidelink transmission resources to the transmission UE 501 according to at least one of a dynamic grant (DG) scheme or a configured grant (CG) scheme.

In the case of the dynamic grant (DG) scheme, as the gNB 503 transmits DCI to the transmission UE 501, resources for one transport block (TB) transmission may be allocated. Sidelink scheduling information included in the DCI may include resource pool information, a parameter related to an initial transmission time point and/or a retransmission time point, and a parameter related to a frequency allocation location information field. The DCI for the dynamic grant scheme may be cyclic redundancy check (CRC)-scrambled based on a sidelink radio network temporary identifier (SL-RNTI) in order to indicate that a transmission resource allocation scheme is the dynamic grant scheme.

In the case of the configured grant (CG) scheme, it is possible to periodically allocate resources for transmitting a plurality of TBs by configuring a semi-persistent scheduling (SPS) interval in Uu-RRC. In this case, as the gNB 503 transmits DCI to the transmission UE 501, resources for a plurality of TBs may be allocated. Sidelink scheduling information included in the DCI may include the parameter related to the initial transmission time point and/or the parameter related to the retransmission time point, and the parameter related to the frequency allocation location information field. In the case of the configured grant scheme, the initial transmission time point (occasion) and/or the retransmission time point, and the frequency allocation location may be determined according to the transmitted DCI, and the resources may be repeated at SPS intervals. DCI for the configured grant scheme may be CRC-scrambled based on an SL-CS-RNTI in order to indicate that the transmission resource allocation scheme is the configured grant scheme. Further, the configured grant scheme may be divided in a type 1 CG and a type 2 CG. In the case of the type 2 CG, the gNB 503 may activate and/or deactivate resources configured by the configured grant through DCI. Accordingly, in the case of mode 1, the gNB 503 may transmit DCI through the PDCCH, so as to indicate final scheduling for sidelink communication with the reception UE 502 to the transmission UE 501.

When broadcast transmission is performed between the UEs 501 and 502, the transmission UE 501 may broadcast an SCI to the reception UE 502 through the PSCCH without any additional PC5-RRC configuration (operation 511) in operation 519. Further, in operation 521, the transmission UE 501 may broadcast data to the reception UE 502 through the PSSCH.

When unicast or groupcast transmission is performed between the UEs 501 and 502, the transmission UE 501 may make a one-to-one RRC connection with other UEs (for example, the reception UE 502) in operation 511. In this case, the RRC connection between the UEs 501 and 502 may be referred to as PC5-RRC to be distinguished from Uu-RRC. In the case of the groupcast transmission scheme, the PC5-RRC connection may be individually configured between UEs within the group. Referring to FIG. 5, although it is illustrated that the connection of PC5-RRC (operation 511) is the operation after transmission of the sidelink SIB (operation 507 and operation 509), the PC5-RRC connection (operation 511) may be performed before transmission of the sidelink SIB or broadcast of the SCI (operation 519). When the RRC connection between UEs is needed, the sidelink PC5-RRC connection may be performed, and the transmission UE 501 may transmit the SCI to the reception UE 502 through the PSCCH in a unicast or groupcast manner in operation 519. At this time, groupcast transmission of the SCI may be analyzed as group SCI. Further, in operation 521, the transmission UE 501 may transmit data to the reception UE 502 through the PSSCH in a unicast or groupcast manner. In the case of mode 1, the transmission UE 501 may identify sidelink scheduling information included in the DCI received from the gNB 503 and perform sidelink scheduling, based on the sidelink scheduling information. The SCI may be divided into a 1st-stage SCI transmitted through the PSCCH and a 2nd-stage SCI transmitted through the PSSCH, and the 1st-stage SCI may include at least one piece of the following information.
Priority
Frequency resource assignment
Time resource assignment
Resource reservation period
de-modulation reference signal (DMRS) pattern
2nd-stage SCI format
Beta_offset indicator
Number of DMRS port
Modulation and coding scheme
Additional modulation and coding scheme (MCS) table indicator
Physical sidelink feedback channel (PSFCH) overhead indication
Reserved
Conflict information receiver flag

Priority information may be transmitted by a higher layer and is 3 bits, and a priority value of 1 may be 000 and a priority value of 2 may be 001.

In an information field for indicating a reservation interval, an interval between TBs may be indicated by one fixed value when resources for a plurality of TBs (that is, a plurality of MAC protocol data units (PDUs) are selected, and “0” may be indicated as a value of the interval between TBs when resources for one TB are selected.

The 2nd-stage SCI may be included in PSSCH resources indicated to the 1st-stage SCI transmitted in operation 519, and may be transmitted along with data in operation 521. The 2nd-stage SCI may include one or more pieces of the following information.
HARQ process number
New data indicator
Redundancy version
Source ID
Destination ID
HARQ feedback enabled/disabled indicator
Cast type indicator
CSI request
Zone ID
Communication range requirement
Providing/Requesting indicator
Resource combinations
First resource location
Reference slot location
Resource set type
Lowest subChannel indices
Priority
Number of subchannels
Resource reservation period
Resource selection window location
Resource set type
Padding bits

In operation 523, the reception UE 502 transmits information indicating whether data received in operation 521 has been successfully demodulated/decoded to the transmission UE 501 through first HARQ feedback information. The first HARQ feedback information includes ACK (success) or NACK (failure) information, and the reception UE 502 transfer the first HARQ feedback information to the transmission UE 501 through a PSFCH channel. In operation 525, the transmission UE 501 transmits the transmission result to the gNB 503 as second HARQ feedback information, based on the first HARQ feedback information received from the reception UE 502. The second HARQ feedback is transmitted to the gNB through the PUCCH. At this time, the second HARQ feedback information may be or may not be the same as the first HARQ feedback information. Further, the second HARQ feedback information may include a plurality of pieces of first HARQ feedback information. A plurality of first HARQ feedback information may include a plurality of pieces of HARQ feedback information received from one reception UE or one or a plurality of HARQ feedback information received from a plurality of UEs. Through the second HARQ feedback information, the gNB may allocate resources for retransmission or resources for new transmission to the transmission UE 501, or when the transmission UE has no transmission resource to be allocated, resource allocation can be stopped. Transmission resources of the PUCCH in operation 525 may be determined by DCI information which the gNB transmits to the transmission UE through the PDCCH in operation 517. Transmission resources of the PSFCH in operation 523 may be determined by the SCI of the PSCCH in operation 519 or determined by a transmission resource area transmitted and received through the PSSCH in operation 521.

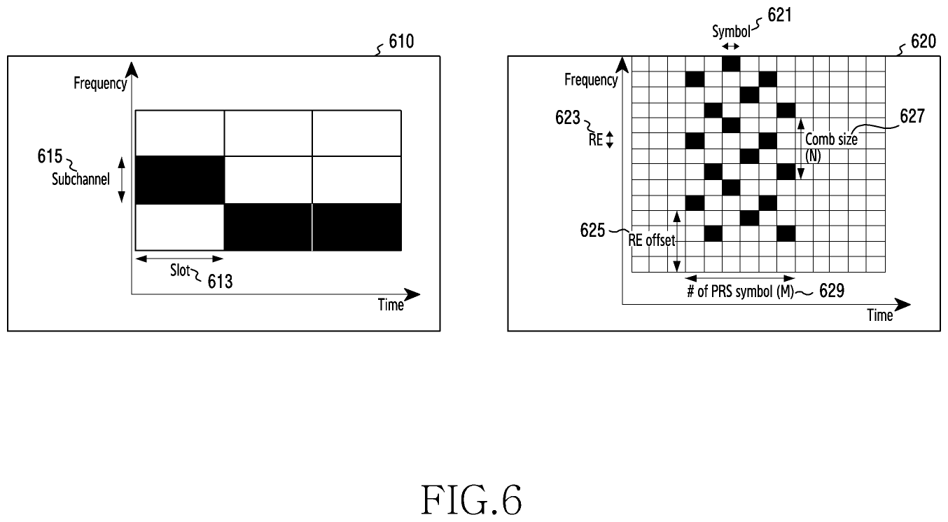

FIG. 6 illustrates the existing sidelink data transmission resource structure and an SL-PRS transmission resource structure according to an embodiment of the disclosure.

Reference numeral 610 describes a structure of transmission resources used for sidelink data transmission. Allocation of transmission resources for sidelink data transmission may be performed in units of subchannels 615 in a frequency resource axis. At this time, one subchannel may include a plurality of PRBs. Allocation of transmission resources for sidelink data transmission may be performed in units of slots 613 in a time resource axis. One slot may include 14 symbols. When the mode 1 scheme described in FIG. 5 is used for the existing sidelink transmission resource allocation, the UE may report size information of data (in other words, transport block) to be transmitted to the gNB (for example, SL-BSR MAC CE may be used), and the gNB may allocate sidelink transmission resources having the size suitable for data transmission to the corresponding size. In order to allocate transmission resources to be used by the UE for sidelink data transmission, the gNB may indicate the location (slot location) in the time axis and the location (subchannel) in the frequency axis of the corresponding transmission resources.

Reference numeral 620 describes a structure of transmission resources used for SL-PRS transmission for sidelink positioning. Transmission resource allocation for SL-PRS transmission may be performed in units of REs 623 in the frequency resource axis. Transmission resource allocation for SL-PRS transmission may be performed in units of symbols 621 in the time resource axis. More specifically, SL-PRS transmission resources may include a plurality of RE patterns that is not successive in the frequency and time axes. Accordingly, resource allocation for SL-PRS transmission may need additional information below compared to the existing resource allocation dedicated for sidelink data transmission of allocating successive resource blocks in frequency and time axes through locations of the subchannel and the slot.
Comb size (N) 627: interval between REs of SL-PRS transmission resources
# of PRS symbol (M) 629: number of symbols of SL-PRS transmission resources

RE offset 625: RE offset of first symbol of SL-PRS transmission resources compared to specific reference point in frequency axis

Since the transmission resource structure used for the existing sidelink data transmission is different from the transmission resource structure used for SL-PRS transmission for performing sidelink positioning as described above, a separate transmission resource request/allocation procedure and method for allocating SL-PR transmission resources different from the existing sidelink transmission resource allocation method described in FIG. 5 may be defined. Accordingly, the disclosure describes a method and a procedure for receiving allocation of transmission resources for SL-PRS transmission by the UE when sidelink positioning is performed. More specifically, the disclosure describes a method and a procedure in which the UE makes a request for resource allocation for SL-PRS transmission to the gNB and the gNB allocates resources for SL-PRS transmission similar to the existing mode 1 scheme.

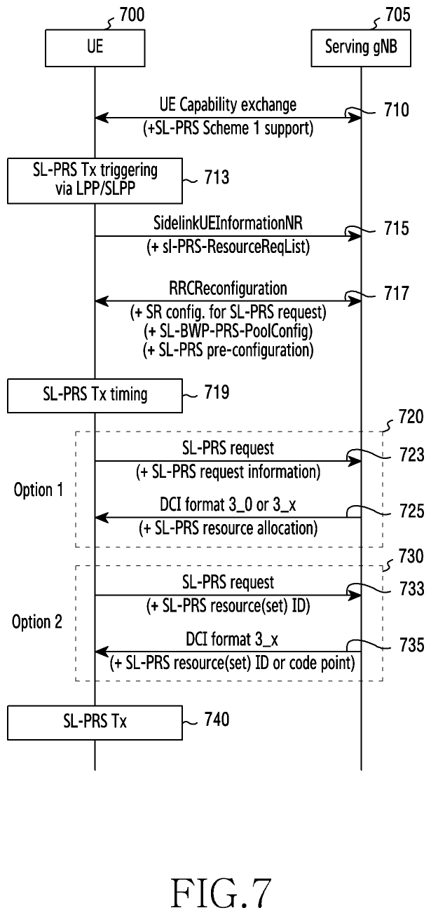

FIG. 7 illustrates an example of signal flow for allocating SL-PRS transmission resources in a dynamic grant scheme according to an embodiment of the disclosure.

Referring to FIG. 7, when a UE 700 needs SL-PRS transmission for performing sidelink positioning, a request for allocating SL-PRS transmission resources may be made to a gNB 705 in order to allocate SL-PRS transmission resources through a scheme similar to the existing mode 1 scheme. The gNB 705 may allocate resources for SL-PRS transmission to the UE 700, based on the SL-PRS transmission resource request information received from the UE 700. More specifically, referring to FIG. 7, the case where a dynamic grant scheme is used in which the UE 700 makes a request for resources required for every SL-PRS transmission and the gNB 705 allocates SL-PRS transmission resources is described. When the SL-PRS transmission resource allocation is performed through the dynamic allocation scheme, a detailed signaling procedure between the UE 700 and the gNB 705 may be described below.

In operation 710, the UE 700 and the gNB 705 may exchange UE capability information related to SL-PRS transmission resource allocation. More specifically, the UE 700 may report on whether SL-PRS transmission resources can be allocated through a scheme similar to the existing mode 1 scheme to the gNB 705. At this time, the UE 700 may report UE capabilities related to an operation of making a request for configuring a sidelink BWP and a resource pool for SL-PRS transmission, an operation of receiving a configuration of a sidelink BWP and a resource pool for SL-PRS transmission, an operation of making a request for allocating SL-PRS transmission resources to the gNB 705, and an operation of receiving allocation of SL-PRS transmission resources. Separate UE capability information may be reported for each operation, or UE capability information may be reported for a combination of one or more of the operations.

In operation 713, the UE 700 may receive an indication of SL-PRS transmission for sidelink positioning from the LMF through LTE positioning protocol (LPP) signaling or an indication of SL-PRS transmission for sidelink positioning from another sidelink UE (for example, a server UE serving as the LMF in sidelink positioning) through a sidelink positioning protocol (SLPP).

In operation 715, the UE 700 may make a request for transmission resources for SL-PRS transmission. To this end, a new field (for example, sl-PRS-ResourceReqList) for an SL-PRS transmission resource request may be defined in the existing SidelinkUEInformationNR message. The list indicated by the field may include one or more pieces of SL-PRS resource request information (for example, SL-PRS-ResourceRequest IE), and each piece of SL-PRS resource request information may include the follow parameters.
sl-DestinationIdentity: indicates a destination of requested/allocated SL-PRS transmission resources
sl-CastType: a cast type corresponding to the destination of the requested SL-PRS transmission resources
sl-PRS-Info: additional information on the requested SL-PRS transmission resources (SL-PRS transmission bandwidth, SL-PRS transmission symbol length, SL-PRS transmission period, and the like)
sl-TxInterestedFreqList: a list including indexes of frequency bands in which the UE is interested for NR sidelink transmission (here, for SL-PRS transmission) A scheme indicating a frequency corresponding to a first entry of sl-FreqInfoList broadcasted through SIB12 when an index value is 1.
sl-CapabilityInformationSidelink: UECapabilityInformationSidelink message received from a peer UE (UE to receive SL-PRS)

In operation 717, the gNB 705 may configure information required for SL-PRS transmission in the UE 700 through an RRCReconfiguration procedure. At this time, SL-PRS transmission-related configuration information may include the following information.
SL-PRS transmission resource pool configuration (for example, SL-BWP-PRS-PoolConfig): may include resource pool information available by the UE for SL-PRS transmission. The shared resource pool or the dedicated resource pool may be configured as the SL resource pool for SL-PRS transmission. The configuration of the shared SL resource pool may mean that a resource pool configured for SL communication is used for transmitting the SL-PRS. The use of the dedicated SL resource pool mean that a resource pool separately configured for SL-PRS transmission is used for transmitting the SL-PRS.
SL-PRS pre-configuration: may include resource allocation configuration information for SL-PRS resources or an SL-PRS resource set. Referring to FIG. 6, the existing sidelink data transmission resources may be specified through slot timing and a subchannel index. Accordingly, there was no significant burden for the gNB 705 to indicate sidelink data transmission resources through DCI in the dynamic grant scheme. In other words, when sidelink transmission resources are allocated through the dynamic grant scheme, an amount of scheduling information that should be included in DCI was small. On the other hand, since SL-PRS resources are configured in a pattern of discontinuous REs, additional information (for example, information on Comb size, # of PRS symbol, and RE offset described in FIG. 6) should be transmitted to the UE 700 for resource allocation. Accordingly, when SL-PRS transmission resources are allocated through the dynamic grant scheme, an amount of information that should be included in DCI increases and thus L1 signaling load may increase. In order to reduce signaling load of DCI used for configuring the SL-PRS transmission resources, the following additional information may be configured in advance in the UE in units of SL-PRS resources or SL-PRS resources sets during an RRCReconfiguration process.
SL-PRS resource ID or SL-PRS resource set ID
SL-PRS-ResourceTriggerList: a list of DCI code points indicating SL-PRS resource (set) transmission When the list is included in a predetermined SL-PRS resource (set) configuration, the UE may receive an indication of the SL-PRS resource (set) through reception of the DCI including at least one of the code points included in the corresponding list.
Destination ID: may directly include a destination L2 ID of an SL-PRS reception UE. Alternatively, in order to reduce signaling load, the destination ID may include the index value of the entry included in sl-PRS-ResourceReqList which the UE includes in the SidelinkUEInformationNR message in operation 715. When the gNB indicates the destination as the entry index value, the UE may analyze sl-DestinationIdentity within the SL-PRS-ResourceRequest IE corresponding to the corresponding index as the destination ID.
SL-PRS pattern information: Comb size, # of PRS symbol, and RE offset
SL-PRS sequence ID
SL-PRS transmission time: frame offset, slot offset, and symbol offset information required for calculating an SL-PRS transmission time point, based on a dynamic grant DCI reception time point.
Number and time interval of SL-PRS repetitive transmissions (repetitions): the number of repetitive SL-PRS transmissions and a time interval between SL-PRS transmissions when the SL-PRS should be repeatedly transmitted.
Scheduling request configuration for SL-PRS request: the UE may transmit an SL-PRS request message to the gNB to make a dynamic grant request like in operation 723. At this time, separate scheduling request resources (for example, schedulingRequestID) may also be configured to make a request for a UL grant to transmit the SL-PRS request message. Accordingly, the UE may rapidly receive allocation of the UL grant through the configured SR resources instead of receiving allocation of the UL grant through an RACH process in a situation where there is no UL grant to transmit the SL-PRS request message, and as a result, reduce a delay time required for SL-PRS transmission resource allocation.

In operation 719, a time point where the UE 700 should transmit the SL-PRS may arrive. At this time, the UE 700 may receive allocation of transmission resources for SL-PRS transmission using one of the following two options through the dynamic grant scheme.
Option #1 720: Option 1 may be used when SL-PRS pre-configuration is not configured in the RRCReconfiguration procedure of operation 717.

In operation 723, the UE 700 may make a request for SL-PRS transmission resources to the gNB 705. As messages for making a request for SL-PRS transmission resources, a PHY layer L1 signal, a MAC layer MAC CE, and an RRC layer message may be used. When there is no UL grant required for transmitting the message making a request for SL-PRS transmission resources, the UE 700 may transmit an SL-PRS transmission resource request message by using scheduling request resources configured by the gNB 705 for the SL-PRS transmission resource request in operation 717. The UE 700 may include the following information as additional information (or requirements) on SL-PRS transmission resources while making a request for allocating SL-PRS transmission resources to the gNB 705.
Destination ID: may directly include a destination L2 ID of an SL-PRS reception UE. Alternatively, in order to reduce signaling load, the destination ID may include the index value of the entry included in sl-PRS-ResourceReqList which the UE includes in the SidelinkUEInformationNR message in operation 715. When the gNB indicates the destination as the entry index value, the UE may analyze sl-DestinationIdentity within the SL-PRS-ResourceRequest IE corresponding to the corresponding index as the destination ID.
SL-PRS Bandwidth: may include the size of a BW through which the SL-PRS is transmitted. Since the accuracy of sidelink positioning varies depending on the size of the BW through which SL-PRS is transmitted, requirements for an SL-PRS bandwidth may be configured in the UE by higher-layer signaling (LPP or SLPP), and the UE may insert the corresponding information into the SL-PRS transmission resource request.
SL-PRS Frequency: may include a frequency in which the SL-PRS is to be transmitted. As frequency information, frequency absolute location information such as an absolute radio frequency channel number (ARFCN) may be used. Alternatively, as frequency information, entry index information of sl-FreqInfoList broadcasted through SIB12 may be used. Alternatively, sl-Freq-ID information within SL-FreqConfig information configured by the gNB during the RRCReconfiguration procedure of operation 171 may be used.
SL-PRS pattern information: Comb size (N), and Symbol length (M)
SL-PRS resource allocation delay time: may include requirements for a delay time until actual SL-PRS transmission resources are allocated after a request for allocating SL-PRS transmission resources (for example, a maximum value of a tolerable delay time).

In operation 725, the gNB 705 may allocate SL-PRS transmission resources to the UE 700 through DCI. When the shared resource pool is used as the SL-PRS transmission resource pool in operation 717, the gNB 705 may allocate SL-PRS transmission resources by using previously defined DCI format 3_0 like in operation 517 of FIG. 5. In the case of the shared resource pool, the existing UEs which do not support SL-PRS transmission use the corresponding resource pool for sidelink data communication, and thus existing DCI format 3_0 may be used considering backward compatibility issues even if new DCI format 3_X is newly defined for SL-PRS transmission resource allocation. In this case, as indicated by reference numeral 610 of FIG. 6, successive SL transmission resource blocks may be allocated in units of slots and subchannels, and the UE 700 may transmit the SL-PRS within the corresponding resources. However, in this case, the remaining resources may be wasted expect for RE pattern resources used for SL-PRS transmission within the SL transmission resource blocks allocated to the UE 700. When the dedicated resource pool is used as the SL-PRS transmission resource pool in operation 717, the gNB 705 may use existing DCI format 3_0 or new DCI format 3_X to configure SL-PRS transmission resources. In the case of DCI format 3_X, a detailed indication of SL-PRS resources including a plurality of RE patterns that are not successive in the frequency and time axes may be defined as indicated by reference numeral 620 of FIG. 6. Accordingly, the following information may be additionally included in new DCI format 3_X in addition to the information included in existing DCI format 3_0.
SL-PRS pattern information: Comb size (N), # of SL-PRS symbol (M), and RE offset 625
SL-PRS sequence ID
SL-PRS transmission time: frame offset, slot offset, and symbol offset information required for calculating an SL-PRS transmission time point, based on a dynamic grant DCI reception time point.
Number and time interval of SL-PRS repetitive transmissions (repetitions): the number of repetitive SL-PRS transmissions and a time interval between SL-PRS transmissions when the SL-PRS should be repeatedly transmitted.
Option #2 730: Option 2 may be used when SL-PRS pre-configuration is configured in the RRCReconfiguration procedure of operation 717.

In operation 733, the UE 700 may make a request for SL-PRS transmission resources to the gNB 705. As messages for SL-PRS transmission, a PHY layer L1 signal, a MAC layer MAC CE, and an RRC layer message may be used. When there is no UL grant required for transmitting the message making a request for SL-PRS transmission resources, the UE 700 may transmit an SL-PRS transmission resource request message by using scheduling request resources configured by the gNB 705 for the SL-PRS transmission resource request in operation 717. The UE 700 may include the following information as additional information (or requirements) on SL-PRS transmission resources while making a request for allocating SL-PRS transmission resources to the gNB 705.
Destination ID: may directly include a destination L2 ID of an SL-PRS reception UE. Alternatively, in order to reduce signaling load, the destination ID may include the index value of the entry included in sl-PRS-ResourceReqList which the UE includes in the SidelinkUEInformationNR message in operation 715. When the gNB indicates the destination as the entry index value, the UE may analyze sl-DestinationIdentity within the SL-PRS-ResourceRequest IE corresponding to the corresponding index as the destination ID.
SL-PRS resource (set) ID: the UE may include one or a plurality of ID values of SL-PRS resources or SL-PRS resource sets to be transmitted to make a request for allocating some of the SL-PRS transmission resources included in the SL-PRS pre-configuration configured in the UE in operation 717.

In operation 735, the gNB 705 may allocate transmission resources (or transmission indication) for the SL-PRS resources or the SL-PRS resource sets through which the UE 700 makes the request for allocating transmission resources in operation 733. To this end, the gNB 705 may use new DCI format 3_X. At this time, DCI format 3_X may additionally include a combination of one or more of the following information in addition to the information included in existing DCI format 3_0.
SL-PRS resource ID or SL-PRS resource set ID: an ID value of SL-PRS resources or SL-PRS resource sets indicating transmission to the UE (allocating transmission resources).
SL-PRS-ResourceTrigger code point: when SL-PRS-ResourceTriggeringList is included in the SL-PRS resource (set) configuration in the SL-PRS pre-configuration in operation 717, the gNB 705 may allocate transmission resources (or indicate transmission) to one or more SL-PRS resource (sets) by inserting at least one of the code points included in SL-PRS-ResourceTriggeringList into the DCI. When the code point for transmission resource allocation (or transmission indication) of the SL-PRS resource (sets) is included in the DCI, the UE 700 may transmit the SL-PRS resource (sets) configured together with SL-PRS-ResourceTriggeringList including the corresponding code point among the SL-PRS resource (sets) included in the SL-PRS pre-configuration in operation 717.

In operation 740, the UE 700 may transmit SL-PRSs through the allocated SL-PRS transmission resources in option #1 720 or option #2 730. In SL-PRS transmission, the UE 700 may transmit the 1st stage SCI and the 2nd stage SCI through the PDCCH and the PSSCH, respectively, like in operations 519 and 521 of FIG. 5, thereby sharing SL-PRS transmission resource allocation information with adjacent UEs. When the shared resource pool is configured for SL-PRS transmission resources, the UE 700 may reuse the previously defined 1st stage SCI in consideration of backward compatibility issues of the exiting UEs that do not support SL-PRS transmission. However, the 2nd stage SCI may be newly defined to exchange additional SL-PRS transmission resource allocation information between UEs that support SL-PRS transmission. When the dedicated resource pool is configured for SL-PRS transmission resources, the UE 700 may use the newly defined 1st stage SCI and 2nd stage SCI to share SL-PRS resource configuration information. The newly defined 1st stage SCI and 2nd stage SCI may additionally include one or more pieces of the following information in addition to the information included in the previously defined 1st stage SCI and 2nd stage SCI to express RE pattern information of SL-PRS transmission resources.
SL-PRS pattern information: Comb size (N), # of SL-PRS symbol (M), and RE offset 625
SL-PRS sequence ID
SL-PRS transmission time: frame offset, slot offset, and symbol offset information required for calculating an SL-PRS transmission time point, based on a dynamic grant DCI reception time point.
Number and time interval of SL-PRS repetitive transmissions (repetitions): the number of repetitive SL-PRS transmissions and a time interval between SL-PRS transmissions when the SL-PRS should be repeatedly transmitted

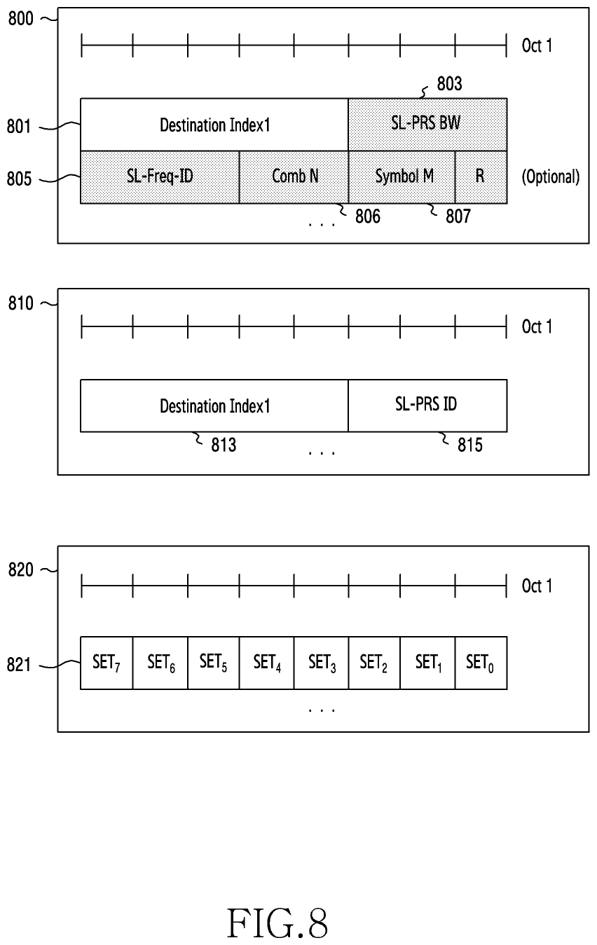

FIG. 8 illustrates an example of a MAC CE format used when SL-PRS transmission resources are allocated in a dynamic grant scheme according to an embodiment of the disclosure.

When the MAC CE is used as the SL-PRS transmission resource request message in operation 723 of FIG. 7, a new MAC CE may be defined as indicated by reference numeral 800. At this time, an (e)LCID value corresponding to the new MAC CE may be also defined.
Destination Index 801: may include the index value of the entry included in sl-PRS-ResourceReqList which the UE 700 includes in the SidelinkUEInformationNR message in operation 715 of FIG. 7. When the gNB 705 indicates the destination as the entry index value, the UE 700 may analyze sl-DestinationIdentity within the SL-PRS-ResourceRequest IE corresponding to the corresponding index as the destination ID. Alternatively, a destination L2 ID of the SL-PRS reception UE may be directly included.
SL-PRS BW 803: may include the size of a BW through which the SL-PRS is transmitted. Since the accuracy of sidelink positioning varies depending on the size of the BW through which SL-PRS is transmitted, requirements for an SL-PRS bandwidth may be configured in the UE by higher-layer signaling (LPP or SLPP), and the UE may insert the corresponding information into the SL-PRS transmission resource request. Since there is no requirement for the Sl-PRS transmission BW, an optional field may be defined.
SL-Freq-ID 805: may include a frequency in which the SL-PRS is to be transmitted. As the frequency information, sl-Freq-ID information within SL-FreqConfig information configured by the gNB 705 during the RRCReconfiguration procedure in operation 717 of FIG. 7 may be used. Alternatively, as frequency information, entry index information of sl-FreqInfoList broadcasted through SIB12 may be used. When only one resource pool for SL-PRS transmission is configured in operation 717 of FIG. 7, the UE 700 does not need to transfer frequency information for SL-PRS transmission to the gNB 705. Accordingly, an operational field may be defined.
Comb N 806: interval between REs of SL-PRS transmission resources Since there is no UE requirement for the SL-PRS pattern, an optional field may be defined.
Symbol M 807: number of symbols of SL-PRS transmission resources. Since there is no UE requirement for the SL-PRS pattern, an optional field may be defined.
SL-PRS resource allocation delay time: may include requirements for a delay time until actual SL-PRS transmission resources are allocated after a request for allocating SL-PRS transmission resources (for example, a maximum value of a tolerable delay time). Since there is no UE requirement for the SL-PRS transmission delay, an optional field may be defined.

In addition, when the MAC CE in the form indicated by reference numeral 800 is used, the UE may insert a plurality of destination indexes 801 and additional information 803, 805, 806, and 807 corresponding thereto into the corresponding MAC CE in order to support a request for allocating one or more SL-PRS transmission resources through one MAC CE transmission.

When the MAC CE is used as the SL-PRS transmission resource request message in operation 733 of FIG. 7, a new MAC CE may be defined as indicated by reference numeral 810 or 820. At this time, an (e)LCID value corresponding to the new MAC CE may be also defined.

When the MAC CE for the SL-PRS transmission resource request is defined as indicated by reference numeral 810, the following information may be included.
Destination Index 813: may include the index value of the entry included in sl-PRS-ResourceReqList which the UE 700 includes in the SidelinkUEInformationNR message in operation 715 of FIG. 7. When the gNB 705 indicates the destination as the entry index value, the UE 700 may analyze sl-DestinationIdentity within the SL-PRS-ResourceRequest IE corresponding to the corresponding index as the destination ID. Alternatively, a destination L2 ID of the SL-PRS reception UE may be directly included.
SL-PRS resource (set) ID 815: the UE may include an ID value of the SL-PRS resource (set) to make a request for transmission resources in order to make a request for allocating resources among some of the SL-PRS transmission resources included in SL-PRS pre-configuration configured in the UE 700 in operation 717 of FIG. 7.

In addition, when the MAC CE in the form indicated by reference numeral 810 is used, the UE may insert a plurality of destination indexes 813 and the SL-PRS resource (set) ID 815 into the corresponding MAC CE in order to support a request for allocating one or more SL-PRS transmission resources through one MAC CE transmission.

When the MAC CE for the SL-PRS transmission resource request is defined as indicated by reference numeral 820, 1 bit corresponding to a SET i within the MAC CE may be used to indicate the transmission resource allocation request for an SL-PRS resource (set) having an SL-PRS resource (set) ID (or index) i within the SL-PRS pre-configuration in operation 717 of FIG. 7. When the SET i bit value is configured as “1”, it may mean a transmission resource allocation request for an SL-PRS resource (set) having an SL-PRS resource (set) ID (or index) I value.

The MAC CE in the format indicated by reference numeral 820 can be used only when the SL-PRS resource (set) configuration included in the SL-PRS pre-configuration already includes destination information in operation 717 of FIG. 7. Further, when the MAC CE in the format indicated by reference numeral 821 is used, the UE has advantageous of simultaneously making a request for allocating resources among a plurality of SL-PRS resource (sets) only with small signaling load.

Examples of MAC CE formats illustrated in FIG. 8 are representative embodiments of various MAC CE formats that can be defined for the SL-PRS transmission resource allocation request, and names of information included in the MAC CE and the number of bits for including the corresponding information may vary.

Further, the MAC CE newly defined for the SL-PRS transmission resource allocation request may have the same priority as a prioritized SL-BSR MAC CE or an SL-BSR MAC CE in a MAC layer LCP operation.

Logical channels shall be prioritized in accordance with the following order (highest priority listed first):
MAC CE for C-RNTI, or data from UL-CCCH;
MAC CE for (Enhanced) BFR, or MAC CE for Configured Grant Confirmation, or MAC CE for Multiple Entry Configured Grant Confirmation;
MAC CE for Sidelink Configured Grant Confirmation;
MAC CE for LBT failure;
MAC CE for Timing Advance Report;
MAC CE for SL-BSR prioritized according to clause 5.22.1.6 (Option 1) or MAC CE for SL-PRS-Request;
MAC CE for (Extended) BSR, with exception of BSR included for padding;
MAC CE for (Enhanced) Single Entry PHR, or MAC CE for (Enhanced) Multiple Entry PHR;
MAC CE for Positioning Measurement Gap Activation/Deactivation Request;
MAC CE for the number of Desired Guard Symbols;
MAC CE for Case-6 Timing Request;
MAC CE for (Extended) Pre-emptive BSR;
MAC CE for SL-BSR, with exception of SL-BSR prioritized according to clause 5.22.1.6 and SL-BSR included for padding (Option 2) or MAC CE for SL-PRS-Request;
MAC CE for IAB-MT Recommended Beam Indication, or MAC CE for Desired IAB-MT PSD range, or MAC CE for Desired DL Tx Power Adjustment;
data from any Logical Channel, except data from UL-CCCH;
MAC CE for Recommended bit rate query;
MAC CE for BSR included for padding;
MAC CE for SL-BSR included for padding.

NOTE 2: Prioritization among MAC CEs of same priority is up to UE implementation.

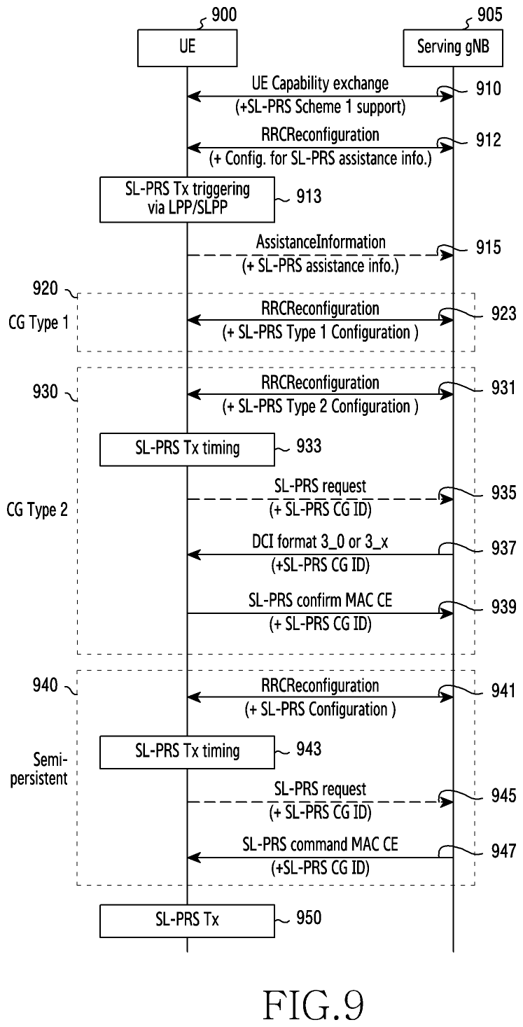

FIG. 9 illustrates an example of signal flow for allocating periodic SL-PRS transmission resources according to an embodiment of the disclosure.

Referring to FIG. 9, when a UE 900 needs periodic SL-PRS transmission to perform sidelink positioning, the UE 900 may provide assistance information related to an SL-PRS transmission pattern and period (for example, SL-PRS assistance information) to the gNB 905 in order to receive allocation of SL-PRS transmission resources through a scheme similar to the existing mode 1 scheme. The gNB 905 may allocate resources for periodic SL-PRS transmission to the UE 900, based on the assistance information received from the UE 900. More specifically, in the embodiment of FIG. 9, the case where the UE 900 provides the gNB 905 with assistance information related to the SL-PRS transmission pattern and period to periodically transmit the SL-PRS and the gNB 905 allocates periodic SL-PRS transmission resources through configured grant type 1, configured grant type 2, or semi-persistent scheme. In this case, a detailed signaling procedure between the UE 900 and the gNB 905 may be described below.

In operation 910, the UE 900 and the gNB 905 may exchange UE capability information related to SL-PRS transmission resource allocation. More specifically, the UE 900 may report on whether SL-PRS transmission resources can be allocated through a scheme similar to the existing mode 1 scheme to the gNB 905. At this time, the UE 900 may report UE capabilities related to an operation of making a request for configuring a sidelink BWP and a resource pool for SL-PRS transmission, an operation of receiving a configuration of a sidelink BWP and a resource pool for SL-PRS transmission, an operation of making a request for allocating SL-PRS transmission resources to the gNB 905, an operation of receiving allocation of SL-PRS transmission resources, an operation of providing assistance information related to SL-PRS transmission to the gNB 905, a configured grant type 1 configuration operation for a periodic SL-PRS resource configuration, a configured grant type 2 configuration operation for a periodic SL-PRS resource configuration, and a semi-persistent SL-PRS configuration operation for a periodic SL-PRS resource configuration. Separate UE capability information may be reported to the gNB for each operation, or UE capability information may be reported to the gNB 905 for a combination of one or more of the operations.

In operation 912, the gNB 905 may configure the UE 900 to report SL-PRS-related assistance information required for periodically configuring SL-PRS resources to the gNB 905 through an RRCReconfiguration procedure. At this time, in order to prevent the UE 900 from too much frequently reporting the SL-PRS-related assistance information to the gNB 905, a separate prohibit timer may also be configured.

In operation 913, the UE 900 may receive an indication of SL-PRS transmission for sidelink positioning from the LMF through LTE positioning protocol (LPP) signaling or an indication of SL-PRS transmission for sidelink positioning from another sidelink UE (for example, a server UE serving as the LMF in sidelink positioning) through a sidelink positioning protocol (SLPP).

When new SL-PRS transmission pattern information is generated or the reported existing SL-PRS transmission pattern information is changed after the UE 900 is configured to report SL-PRS-related assistance information to the gNB 905 in operation 912, transmission of a predetermined RRC message (for example, UEAssistanceInformation or SidelinkUEInformationNR) for reporting the SL-PRS-related assistance information to the gNB 905 may be triggered in operation 915. At this time, when a prohibit timer related to the SL-PRS assistance information is not run, an RRC message for reporting SL-PRS-related assistance information may be transmitted. On the other hand, when the prohibit timer related to the SL-PRS assistance information is run, an RRC message for reporting SL-PRS-related assistance information cannot be transmitted. The SL-PRS-related assistance information may include one or more pieces of the following information.
sl-DestinationIdentity: destination of SL-PRS transmission
Resource Type: SL-PRS transmission type (e.g., periodic, semi-persistent)
SL-PRS Frequency: SL-PRS transmission frequency (e.g., FR1/2, sl-Freq-ID, NR ARFCN, . . . )
SL-PRS BW: SL-PRS transmission bandwidth (e.g., 5, 10, 20 . . . MHz)
SL-PRS periodicity: SL-PRS transmission period
# of periodic SL-PRS Tx: number of SL-PRS transmissions
SL-PRS timing: SL-PRS transmission start time point information (e.g., timing offset)
SL-PRS pattern information: Comb size (N), SL-PRS symbol length (M)

The gNB 905 receiving the SL-PRS-related assistance information reported by the UE 900 may use at least one of the configured grant (CG) type 1 scheme 920, the CG type 2 scheme 930, or the semi-persistent scheme 940 to periodically allocate SL-PRS transmission resources, based on the corresponding assistance information in operation 915.
CG Type1 scheme 920: the gNB 905 may configure periodic SL-PRS transmission resources in the UE 900 through the CG type 1 scheme (a scheme of configuring a sidelink configured grant for periodic SL-PRS transmission only through RRC signaling) through the RRCReconfiguration procedure in operation 923. In order to configure the sidelink configured grant for SL-PRS transmission (hereinafter, referred to an SL-PRS CG to make the description easy) through the CG type 1 scheme, at least one piece of the following information may be included in the RRCReconfiguration message for each SL-PRS CG configuration.
SL-PRS CG ID: SL-PRS CG ID or SL-PRS resource (set) ID
SL-PRS sequence ID
sl-DestinationIdentity: destination of SL-PRS transmission
SL-PRS CG periodicity: sidelink configured grant period for SL-PRS transmission
sl-ResourcePoolID: ID of resource pool to which SL-PRS CG Type1 is applied
SL-PRS CG time information: sidelink configured grant start timing information for SL-PRS transmission (for example, existing system frame number (SFN), slot offset from reference SFN, and symbol offset within slot)
SL-PRS CG frequency resource information: frequency resource information of sidelink configured grant for SL-PRS transmission (sidelink, frequency, and start subchannel index)
SL-PRS pattern information: Comb size (N), # of SL-PRS symbol (M), and RE offset 625

The above-described SL-PRS CG configuration may be expressed by another term such as an SL-PRS resource configuration or an SL-PRS resource set configuration.
CG Type2 scheme 930: the gNB 905 may configured periodic SL-PRS transmission resources in the UE 900 through the CG type 2 scheme (scheme of pre-configuring some of the sidelink configured grants for periodic SL-PRS transmission through RRC signaling, transmitting additional information through DCI, and activating the CG) through the RRCReconfiguration procedure in operation 931. In order to configure SL-PRS transmission resources of the CG type 2 scheme, at least one piece of the following information may be included in RRCReconfiguration message for each SL-PRS CG configuration.
SL-PRS CG ID: SL-PRS CG ID or SL-PRS resource (set) ID
SL-PRS sequence ID
sl-DestinationIdentity: destination of SL-PRS transmission
SL-PRS CG periodicity: SL-PRS CG period
SL-PRS pattern information: Comb size (N), # of SL-PRS symbol (M), and RE offset

In operation 933, a time point at which the UE 900 should start SL-PRS transmission may arrive.

In operation 935, the UE 900 may transmit an SL-PRS request message to the gNB 905 in order to make a request for activating one or a plurality of type 2 CG configurations for SL-PRS transmission configured through the RRCReconfiguration procedure in operation 931. At this time, as the SL-PRS request messages, a PHY layer L1 signal, a MAC layer MAC CE, and an RRC layer message may be used. The SL-PRS request message may include one or more SL-PRS CG ID values to be activated or deactivated.

In operation 937, the gNB 905 may indicate activation of one or a plurality of type 2 CG configurations for SL-PRS transmission through the DCI during the RRCReconfiguration procedure in operation 931. To this end, the DCI may include ID values of SL-PRS CGs to be activated or deactivated and additional CG scheduling information (for example, CG start timing information and CG frequency resource information). Further, the DCI transmitted to activate or deactivate SL-PRS CG type 2 may be CRC-scrambled based on a separate RNTI (for example, an SL-PRS-RNTI).

In operation 939, the UE 900 may transmit a MAC CE for reporting, to the gNB 905, that the indication of activation or deactivation of SL-PRS CG type 2 through the DCI in operation 937 has been normally received. Through the corresponding MAC CE, the UE 900 may report, to the gNB, an active or inactive state of each of the type 2 CG configurations for SL-PRS transmission configured through the RRCReconfiguration procedure in operation 931.

The above-described SL-PRS CG configuration may be expressed by another term such as an SL-PRS resource configuration or an SL-PRS resource set configuration.
Semi-persistent scheme 940: the gNB 905 may transmit a sidelink configured grant for periodic SL-PRS transmission (hereinafter, referred to as an SL-PRS CG to make the description easy) through the RRCReconfiguration procedure in operation 941. At this time, the RRCReconfiguration message may include one or more pieces of the following information for each SL-PRS CG configuration.
SL-PRS CG ID: SL-PRS CG ID or SL-PRS resource (set) ID
SL-PRS sequence ID
sl-DestinationIdentity: destination of SL-PRS transmission
SL-PRS CG periodicity: sidelink configured grant period for SL-PRS transmission
sl-ResourcePoolID: ID of resource pool to which SL-PRS CG Type1 is applied
SL-PRS CG time information: sidelink configured grant start timing information for SL-PRS transmission (for example, existing system frame number (SFN), slot offset from reference SFN, and symbol offset within slot)
SL-PRS CG frequency resource information: frequency resource information of sidelink configured grant for SL-PRS transmission (sidelink, frequency, and start subchannel index)
SL-PRS pattern information: Comb size (N), # of SL-PRS symbol (M), and RE offset 625

The above-described SL-PRS CG configuration may be expressed by another term such as an SL-PRS resource configuration or an SL-PRS resource set configuration.

In operation 945, the UE 900 may transmit an SL-PRS request message to the gNB 905 in order to make a request for activating one or a plurality of SL-PRS CG configurations configured through the RRCReconfiguration procedure in operation 941. At this time, as the SL-PRS request messages, a PHY layer L1 signal, a MAC layer MAC CE, and an RRC layer message may be used. The SL-PRS request message may include one or more ID values of SL-PRS CGs to be activated or deactivated.

In operation 947, the gNB 905 may transmit a MAC CE (for example, an SL-PRS command MAC CE) in order to indicate activation of one or more of the SL-PRS CG configurations configured through the RRCReconfiguration procedure in operation 941 to the UE 900. To this end, the MAC CE may include one or more ID values of SL-PRS CGs to be activated or deactivated.

The above-described SL-PRS CG configuration may be expressed by another term such as an SL-PRS resource configuration or an SL-PRS resource set configuration.

In operation 950, the UE 900 may perform periodic SL-PRS transmission through configured grant resources for SL-PRS transmission allocated through the CG type 1 scheme 920, the CG type 2 scheme 930, or the semi-persistent scheme 940.

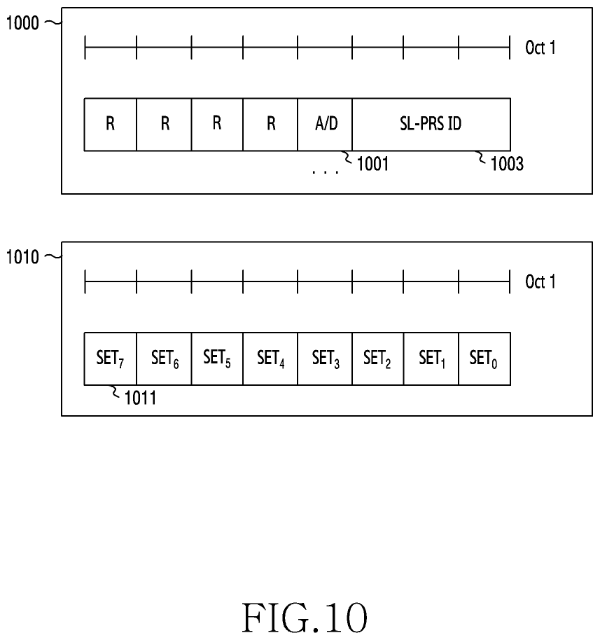

FIG. 10 illustrates an example of a MAC CE format used when periodic SL-PRS transmission resources are allocated according to an embodiment of the disclosure.

In operations 935 and 945 of FIG. 9, when a MAC CE is used as an SL-PRS request message, a new MAC CE may be defined as indicated by reference numeral 1000 or 1010. At this time, an (e)LCID value corresponding to the new MAC CE may be also defined.

In operations 935 and 945, when the MAC CE used as the SL-PRS request message is defined as indicated by reference numeral 1000, information included in the corresponding MAC CE may be described below.
A/D as indicated by reference numeral 1001: may use 1 bit to indicate whether the corresponding MAC CE is for a request for activating or deactivating the SL-PRS CG configuration. The UE may configure a value of the A/D bit as “1” when the MAC CE is transmitted to activate the SL-PRS CG configuration. On the other hand, the UE may configure a value of the A/D bit as “0” when the MAC CE is transmitted to deactivate the SL-PRS CG configuration.
SL-PRS ID as indicated by reference numeral 1003: may include an SL-PRS CG ID (or index) value of which activation or deactivation is requested through the MAC CE. If the UE makes a request for activating or deactivating a plurality of SL-PRS CGs through MAC CE transmission, a plurality of SL-PRS IDs may be included in the MAC CE.

When the MAC CE used as the SL-PRS request message in operations 935 and 945 of FIG. 9 is defined as indicated by reference numeral 1010, 1 bit corresponding to a SET i within the MAC CE as indicated by reference numeral 1011 may be used to indicate a request for activating or deactivating the SL-PRS CG having an SL-PRS CG ID (or index) i configured in operations 931 and 941 of FIG. 9. When the SET i bit value is configured as “1”, it may mean a request for activating transmission of the SL-PRS CG having the SL-PRS CG ID (or index) i. On the other hand, when the SET i bit value is configured as “0”, it may mean a request for deactivating transmission of the SL-PRS CG having the SL-PRS CG ID (or index) i.

Further, the MAC CE newly defined for the request for activating and deactivating the SL-PRS CG may have the same priority as a prioritized SL-BSR MAC CE or an SL-BSR MAC CE as described below in a MAC layer LCP operation.

Logical channels shall be prioritised in accordance with the following order (highest priority listed first):
MAC CE for C-RNTI, or data from UL-CCCH;
MAC CE for (Enhanced) BFR, or MAC CE for Configured Grant Confirmation, or MAC CE for Multiple Entry Configured Grant Confirmation;
MAC CE for Sidelink Configured Grant Confirmation;
MAC CE for LBT failure;
MAC CE for Timing Advance Report;
MAC CE for SL-BSR prioritized according to clause 5.22.1.6 (Option 1) or MAC CE for SL-PRS-Request;
MAC CE for (Extended) BSR, with exception of BSR included for padding;
MAC CE for (Enhanced) Single Entry PHR, or MAC CE for (Enhanced) Multiple Entry PHR;
MAC CE for Positioning Measurement Gap Activation/Deactivation Request;
MAC CE for the number of Desired Guard Symbols;
MAC CE for Case-6 Timing Request;
MAC CE for (Extended) Pre-emptive BSR;
MAC CE for SL-BSR, with exception of SL-BSR prioritized according to clause 5.22.1.6 and SL-BSR included for padding (Option 2) or MAC CE for SL-PRS-Request;
MAC CE for IAB-MT Recommended Beam Indication, or MAC CE for Desired IAB-MT PSD range, or MAC CE for Desired DL Tx Power Adjustment;
data from any Logical Channel, except data from UL-CCCH;
MAC CE for Recommended bit rate query;
MAC CE for BSR included for padding;
MAC CE for SL-BSR included for padding.

In operation 947 of FIG. 9, an SL-PRS command MAC CE may be defined as indicated by reference numeral 1000 or 1010. At this time, an (e)LCID value corresponding to the new MAC CE may be also defined.

In operation 947 of FIG. 9, when the SL-PRS command MAC CE is defined as 1000, information included in the corresponding MAC CE is described below.
A/D: may use 1 bit to indicate whether the corresponding MAC CE is for an indication of activating or deactivating the SL-PRS CG configuration. The gNB may configure a value of the A/D bit as “1” when the MAC CE is transmitted to indicate activation of the SL-PRS CG configuration. On the other hand, the gNB may configure a value of the A/D bit as “0” when the MAC CE is transmitted to indicate deactivation of the SL-PRS CG configuration.
SL-PRS ID: may include an SL-PRS CG ID (or index) value of which activation or deactivation is indicated through the MAC CE. If the UE desires to indicate activation or deactivation of a plurality of SL-PRS CGs through MAC CE transmission, a plurality of SL-PRS IDs may be included in the MAC CE.

When the SL-PRS command MAC CE in operation 947 of FIG. 9 is defined as indicated by reference numeral 1010, 1 bit corresponding to a SET i within the MAC CE may be used to indicate an indication of activation or deactivation of the SL-PRS CG having an SL-PRS CG ID (or index) i configured in operations 931 and 941 of FIG. 9. When the SET i bit value is configured as “1”, it may mean activation of transmission of the SL-PRS CG having the SL-PRS CG ID (or index) i. On the other hand, when the SET i bit value is configured as “0”, it may mean deactivation of transmission of the SL-PRS CG having the SL-PRS CG ID (or index) i.

In operation 939 of FIG. 9, an SL-PRS confirm MAC CE may be defined as indicated by reference numeral 1010. At this time, an (e)LCID value corresponding to the new MAC CE may be also defined. As indicated by reference numeral 1010, 1 bit corresponding to the SET i within the MAC CE may be used to identify activation or deactivation of the SL-PRS CG having the SL-PRS CG ID (or index) i configured in operations 931 and 941 of FIG. 9. When the SET i bit value is configured as “1”, it may mean that the SL-PRS CG having the SL-PRS CG ID (or index) i is activated. On the other hand, when the SET i bit value is configured as “0”, it may mean that the SL-PRS CG having the SL-PRS CG ID (or index) i is deactivated.

Further, the newly defined MAC CE have the same priority as a MAC CE for (enhanced) BFR, MAC CE for configured grant confirmation, and a MAC CE for multiple entry configured grant confirmation as described below in the MAC layer LCP operation to identify activation and deactivation of the SL-PRS CG.

Logical channels shall be prioritized in accordance with the following order (highest priority listed first):
MAC CE for C-RNTI, or data from UL-CCCH;
MAC CE for (Enhanced) BFR, or MAC CE for Configured Grant Confirmation, or MAC CE for Multiple Entry Configured Grant Confirmation, or MAC CE for SL-PRS Configured grant Confirmation;
MAC CE for Sidelink Configured Grant Confirmation;
MAC CE for LBT failure;
MAC CE for Timing Advance Report;
MAC CE for SL-BSR prioritized according to clause 5.22.1.6;
MAC CE for (Extended) BSR, with exception of BSR included for padding;
MAC CE for (Enhanced) Single Entry PHR, or MAC CE for (Enhanced) Multiple Entry PHR;
MAC CE for Positioning Measurement Gap Activation/Deactivation Request;
MAC CE for the number of Desired Guard Symbols;
MAC CE for Case-6 Timing Request;
MAC CE for (Extended) Pre-emptive BSR;
MAC CE for SL-BSR, with exception of SL-BSR prioritized according to clause 5.22.1.6 and SL-BSR included for padding;
MAC CE for IAB-MT Recommended Beam Indication, or MAC CE for Desired IAB-MT PSD range, or MAC CE for Desired DL Tx Power Adjustment;
data from any Logical Channel, except data from UL-CCCH;
MAC CE for Recommended bit rate query;
MAC CE for BSR included for padding;
MAC CE for SL-BSR included for padding.

The SL-PRS CG described in the embodiment of FIG. 10 may be expressed by another term such as an SL-PRS resource or an SL-PRS resource set.

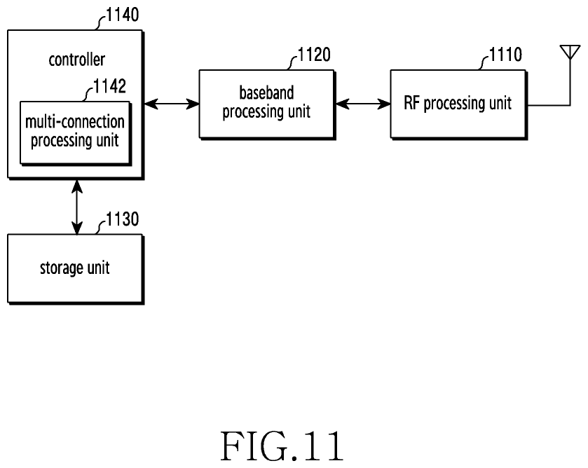

FIG. 11 illustrates a UE apparatus according to an embodiment of the disclosure.

Referring to FIG. 11, a UE may include a radio frequency (RF) processing unit 1110, a baseband processing unit 1120, a storage unit 1130, and a controller 1140. The configuration of the UE is not limited to the configuration illustrated in FIG. 11, and may include fewer or more elements than those illustrated in FIG. 11.

The RF processing unit 1110 may perform a function of transmitting and receiving a signal through a radio channel such as band conversion and amplification of a signal. For example, the RF processing unit 1110 may up-convert a baseband signal provided from the baseband processing unit 1120 into an RC band signal and then transmit the RF band signal through an antenna, and down-convert the RF band signal received through the antenna into the baseband signal. For example, the RF processing unit 1110 may include a transmission filter, a reception filter, an amplifier, a mixer, an oscillator, a digital-to-analog convertor (DAC), an analog-to-digital convertor (ADC), and the like, but is not limited thereto. Although FIG. 2 illustrates only one antenna, the UE may include a plurality of antennas. Further, the RF processing unit 1110 may include a plurality of RF chains. Moreover, the RF processing unit 1110 may perform beamforming. For the beamforming, the RF processing unit 1110 may control a phase and a size of each of the signals transmitted/received through a plurality of antennas or antenna elements. Further, the RF processing unit 1110 may perform MIMO and receive a plurality of layers in the MIMO operation.

The baseband processing unit 1120 may perform a function of conversion between a baseband signal and a bitstream according to a physical layer standard of the system. For example, in data transmission, the baseband processing unit 1120 may encode and modulate a transmission bitstream to generate complex symbols. Further, in data reception, the baseband processing unit 1120 may reconstruct a reception bitstream by decoding and demodulating a baseband signal provided from the RF processing unit 1110. For example, in an orthogonal frequency division multiplexing (OFDM) scheme, when data is transmitted, the baseband processing unit 1120 may encode and modulate a transmission bitstream to generate complex symbols, map the complex symbols to subcarriers, and then configure OFDM symbols through an inverse fast Fourier transform (IFFT) operation or a cyclic prefix (CP) insertion. Further, in data reception, the baseband processing unit 1120 may divide the baseband signal provided from the RF processing unit 1810 in units of OFDM symbols, reconstruct the signals mapped to the subcarriers through a fast Fourier transform (FFT) operation, and then reconstruct a reception bitstream through demodulation and decoding.

The baseband processing unit 1120 and the RF processing unit 1110 may transmit and receive the signal as described above. Accordingly, the baseband processing unit 1120 and the RF processing unit 1110 may be referred to as a transmitter, a receiver, a transceiver, or a communication unit. Further, at least one of the baseband processing unit 1120 and the RF processing unit 1110 may include a plurality of communication modules for supporting a plurality of different radio access technologies. In addition, at least one of the baseband processing unit 1120 and the RF processing unit 1110 may include different communication modules to process signals in different frequency bands. For example, the different radio access technologies may include a wireless LAN (for example, IEEE 802.11) and a cellular network (for example, LTE). Further, the different frequency bands may include a super high frequency (SHF) (for example, 2.NRHz, NRhz) band and a millimeter (mm) wave (for example, 60 GHz) band. The UE may transmit and receive signals to and from the gNB by using the baseband processing unit 1120 and the RF processing unit 1110, and the signals may include control information and data.

The storage unit 1130 may store data such as a basic program for the operation of the UE, an application, and configuration information. For example, the storage unit 1130 may store data information such as a basic program for the operation of the UE, an application program, and configuration information. The storage unit 1130 may provide the stored data according to a request of the controller 1140.

The storage unit 1130 may be configured by storage media such as read only memory (ROM), random access memory (RAM), hard disc, compact disc read only memory (CD-ROM), and digital versatile disc (DVD), or a combination of the storage media. Further, the storage unit 1130 may include a plurality of memories. According to an embodiment of the disclosure, the storage unit 1130 may store a program for performing a handover method according to the disclosure.

The controller 1140 may control the overall operation of the UE. For example, the controller 1140 may transmit and receive a signal through the baseband processing unit 1120 and the RF processing unit 1110.

The controller 1140 may record data in the storage unit 1130 and read the data. To this end, the controller 1140 may include at least one processor. For example, the controller 1140 may include a communication processor (CP) that performs a control for communication, and an application processor (AP) that controls a higher layer such as an application program. According to an embodiment of the disclosure, the controller 1140 may include a multi-connection processing unit 1142 configured to perform a process operating in a multi-connection mode. Further, at least one element in the UE may be implemented as a single chip.

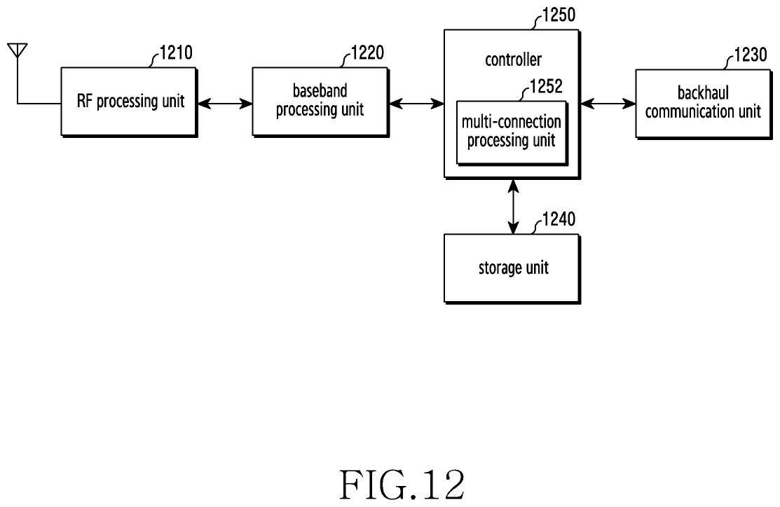

FIG. 12 illustrates a gNB apparatus according to an embodiment of the disclosure.

The gNB of FIG. 12 may be included in the above-described network.

Referring to FIG. 12, the gNB may include an RF processing unit 1210, a baseband processing unit 1220, a backhaul communication unit 1230, a storage unit 1240, and a controller 1250. The configuration of the gNB is not limited to the configuration illustrated in FIG. 3, and the gNB may include fewer or more elements than those illustrated in FIG. 3. The RF processing unit 1210 may perform a function of transmitting and receiving a signal through a radio channel such as band conversion and amplification of a signal. For example, the RF processing unit 1210 may up convert an RF baseband signal into a baseband signal provided from the baseband processing unit 1220 and then transmit the RF baseband signal through an antenna, and down-convert the RF band signal received through the antenna into the baseband signal. For example, the RF processing unit 1210 may include a transmission filter, a reception filter, an amplifier, a mixer, an oscillator, a DAC, and an ADC. Although FIG. 3 illustrates only one antenna, the RF processing unit 1210 may include a plurality of antennas. Further, the RF processing unit 1210 may include a plurality of RF chains. The RF processing unit 1210 may perform beamforming. For beamforming, the RF processing unit 1210 may control a phase and a size of each of the signals transmitted and received through a plurality of antennas or antenna elements. The RF processing unit 1210 may perform a downlink MIMO operation by transmitting one or more layers.

The baseband processing unit 1220 may perform a function of conversion between a baseband signal and a bitstream according to a physical layer standard of the system. For example, in data transmission, the baseband processing unit 1220 may encode and modulate a transmission bitstream to generate complex symbols. Further, in data reception, the baseband processing unit 1220 may reconstruct a reception bitstream by decoding and demodulating a baseband signal provided from the RF processing unit 1210. For example, in an OFDM scheme, when data is transmitted, the base band processing unit 1220 may encode and modulate the transmission bitstream to generate complex symbols, map the complex symbols to subcarriers, and then configure OFDM symbols through an IFFT operation and CP insertion. In addition, when data is received, the baseband processing unit 1220 may divide the baseband signal provided from the RF processing unit 1710 in units of OFDM symbols, reconstruct signals mapped with subcarriers through an FFT operation, and then reconstruct a reception bitstream through demodulation and decoding. The baseband processing unit 1220 and the RF processing unit 1210 may transmit and receive the signal as described above. Accordingly, the baseband processing unit 1220 and the RF processing unit 1210 may be referred to as a transmitter, a receiver, a transceiver, a communication unit, or a wireless communication unit. The gNB may transmit and receive signals to and from the UE by using the baseband processing unit 1220 and the RF processing unit 1210, and the signals may include control information and data.

The backhaul communication unit 1230 may provide an interface for communicating with other nodes within the network. For example, the backhaul communication unit 1230 may convert a bitstream transmitted from the main gNB to another node, for example, an auxiliary gNB, or a core network into a physical signal and convert a physical signal received from another node into a bitstream.

The storage unit 1240 may store data such as a basic program for the operation of the main gNB, an application program, configuration information, and the like. For example, the storage unit 1240 may store information on bearers allocated to the accessed UE and a measurement result reported from the accessed UE. Further, the storage unit 1240 may store information which is a reference for determining whether to provide multiple connections to the UE or stop the connections. The storage unit 1240 may provide the stored data according to a request of the controller 1250. The storage unit 1240 may be configured by storage media such as ROM, RAM, hard discs, CD-ROMs, and DVDs, or a combination of the storage media. Further, the storage unit 1240 may include a plurality of memories. According to an embodiment of the disclosure, the storage unit 1240 may store a program for performing handover according to the disclosure.

The controller 1250 may control the overall operation of the main gNB. For example, the controller 1250 may transmit and receive signals through the baseband processing unit 1220 and the RF processing unit 1210 or through the backhaul communication unit 1230. The controller 1250 may record data in the storage unit 1240 and read the data. To this end, the controller 1250 may include at least one processor. According to an embodiment of the disclosure, the controller 1250 may include a multi-connection processing unit 1252 configured to perform a process operating in a multi-connection mode.

The methods according to the claims of the disclosure or the embodiments described herein may be implemented in the form of hardware, software, or a combination of hardware and software.

When implemented in software, a computer-readable storage medium storing one or more programs (software modules) may be provided. The one or more programs stored on the computer-readable storage medium are configured for execution by one or more processors in the electronic device. The one or more programs include instructions that cause the electronic device to perform methods in accordance with the claims of the disclosure or the embodiments described herein.

These programs (software modules, software) may be stored in random access memory, non-volatile memory, including flash memory, read only memory (ROM), electrically erasable programmable read only memory (EEPROM), magnetic disc storage device, compact disc read only memory (CD-ROM), digital versatile disks (DVDs), and other non-volatile storage devices: (EEPROM), electrically erasable programmable read only memory (EEPROM), magnetic disc storage device, compact disc rom (CD-ROM), digital versatile disks (DVDs) or other forms of optical storage, magnetic cassette, or any combination of any or all of these. Alternatively, it may be stored in memory comprising a combination of any or all of these. Further, there may be a plurality of each of these configurable memories.

Further, the program may be stored on an attachable storage device that is accessible via a communication network, such as a communication network comprising the Internet, an intranet, a local area network (LAN), a wide area network (WLAN), or a storage area network (SAN), or any combination thereof. Such a storage device may be accessible to a device practicing embodiments of the disclosure via an external port. Additionally, a separate storage device on a communication network may be accessible to the device performing the embodiments of the disclosure.

In this disclosure, the terms “computer program product” or “computer readable medium” are used to refer collectively to media such as memory, hard disks installed in a hard disk drive, and signals. Such a “computer program product” or “computer readable medium” is a configuration provided in a method of reporting terminal capabilities in a wireless communication system according to the disclosure.

The device-readable storage medium may be provided in the form of a non-transitory storage medium. As used herein, “non-transitory storage medium” means only that it is a tangible device and does not contain signals (e.g., electromagnetic waves), and the term does not distinguish between cases where data is stored on the storage medium on a semi-permanent basis and cases where data is stored on a temporary basis. For example, a “non-transitory storage medium” may include a buffer in which data is temporarily stored.

In one embodiment, methods according to various embodiments disclosed herein may be provided as part of a computer program product. The computer program product may be a commodity and may be traded between a seller and a buyer. The computer program product may be distributed in the form of a device-readable storage medium (e.g., compact disc read only memory (CD-ROM)), or may be distributed online (e.g., downloaded or uploaded), such as through an application store (e.g., Play Store™) or directly between two user devices (e.g., smartphones). In the case of online distribution, at least a portion of the computer program product (e.g., a downloadable app) may be at least temporarily stored on, or temporarily generated from, a device-readable storage medium, such as a manufacturer's server, an application store's server, or memory of a relay server.

In the specific embodiments of the disclosure described above, the components included in the disclosure have been represented in the singular or plural, depending on the specific embodiment presented. However, the singular or plural representation has been chosen for ease of description and to suit the context presented, and the disclosure is not limited to the singular or plural components, and components represented in the plural may be configured in the singular, or components represented in the singular may be configured in the plural.

The embodiments of the disclosure disclosed herein and in the drawings are illustrated by way of specific examples only to facilitate the technical content of the disclosure and to aid in understanding the disclosure, and are not intended to limit the scope of the disclosure, i.e., it will be apparent to one of ordinary skill in the art that other modifications based on the technical ideas of the disclosure may be practiced. Further, each of the above embodiments may be operated in combination with each other as desired. For example, base stations and terminals may be operated with portions of one embodiment of the disclosure and other embodiments in combination with each other. Furthermore, embodiments of the disclosure are applicable to other communication systems, and other modifications based on the technical ideas of the embodiments may also be practiced. For example, the embodiments may be applicable to LTE systems, 5G, NR systems, or 6G systems.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
transmitting, to a base station, sidelink UE information associated with the UE, wherein the sidelink UE information includes information for requesting a configuration of a resource for a sidelink positioning reference signal (SL-PRS);
receiving, from the base station, configuration information associated with a resource pool for the SL-PRS;
transmitting, to the base station, information for requesting a SL-PRS resource, based on the configuration information;
receiving, from the base station, first downlink control information (DCI) scheduling the SL-PRS resource; and
transmitting the SL-PRS on the SL-PRS resource based on the first DCI.

2. The method of claim 1,
wherein the information for requesting the configuration of the resource includes a transmission resource request comprising a sidelink destination identity for the SL-PRS,
wherein the information for requesting the SL-PRS resource comprises a medium access control (MAC) control element (CE) including a destination index for the SL-PRS resource and information on a bandwidth for the SL-PRS resource, and
wherein the destination index corresponds to the sidelink destination identity.

3. The method of claim 1,
wherein, in case that the resource pool for the SL-PRS is a shared resource pool:
the first DCI is used for scheduling of a physical sidelink control channel (PSCCH) and a physical sidelink shared channel (PSSCH),
wherein, in case that the resource pool for the SL-PRS is a dedicated resource pool:
a SL-PRS resource of the resource pool is configured with a SL-PRS resource identifier (ID), a comb size of the SL-PRS resource, a comb offset of the SL-PRS resource, a number of symbols for the SL-PRS resource, and a symbol offset of the SL-PRS resource, and
the first DCI is used for scheduling of the SL-PRS, and includes information indicating the SL-PRS ID.

4. The method of claim 1,
wherein, in case that the UE is configured to report configured grant assistance information, the method further comprises:
transmitting, to the base station, UE information associated with the UE, the UE information including information on a periodicity and information on a bandwidth of a CG based SL-PRS transmission, and
wherein the configuration information further includes a SL-PRS CG configuration for the CG based SL-PRS transmission comprising a SL-PRS CG identifier (ID) of the SL-PRS CG configuration and a periodicity of the SL-PRS CG configuration.

5. The method of claim 4, further comprising:
receiving, from the base station, second DCI including first information indicating the SL-PRS CG configuration, and second information indicating activation or release of the SL-PRS CG configuration; and
transmitting a CG based periodic SL-PRS based on the second DCI.

6. A method performed by a base station in a wireless communication system, the method comprising:
receiving, from a user equipment (UE), sidelink UE information associated with the UE, wherein the sidelink UE information includes information for requesting a configuration of a resource for a sidelink positioning reference signal (SL-PRS);
transmitting, to the UE, configuration information associated with a resource pool for the SL-PRS;
receiving, from the UE, information for requesting a SL-PRS resource, based on the configuration information; and
transmitting, to the UE, first downlink control information (DCI) scheduling the SL-PRS resource,
wherein the SL-PRS is transmitted on the SL-PRS resource based on the first DCI.

7. The method of claim 6,
wherein the information for requesting the configuration of the resource includes a transmission resource request comprising a sidelink destination identity for the SL-PRS,
wherein the information for requesting the SL-PRS resource comprises a medium access control (MAC) control element (CE) including a destination index for the SL-PRS resource and information on a bandwidth for the SL-PRS resource, and
wherein the destination index corresponds to the sidelink destination identity.

8. The method of claim 6,
wherein, in case that the resource pool for the SL-PRS is a shared resource pool:
the first DCI is used for scheduling of a physical sidelink control channel (PSCCH) and a physical sidelink shared channel (PSSCH), and
wherein, in case that the resource pool for the SL-PRS is a dedicated resource pool:
a SL-PRS resource of the resource pool is configured with a SL-PRS resource identifier (ID), a comb size of the SL-PRS resource, a comb offset of the SL-PRS resource, a number of symbols for the SL-PRS resource, and a symbol offset of the SL-PRS resource, and
the first DCI is used for scheduling of the SL-PRS, and includes information indicating the SL-PRS ID.

9. The method of claim 6,
wherein, in case that the UE is configured to report configured grant assistance information, the method further comprises:
receiving, from the UE, UE information associated with the UE, the UE information including information on a periodicity and information on a bandwidth of a CG based SL-PRS transmission, and
wherein the configuration information further includes a SL-PRS CG configuration for the CG based SL-PRS transmission comprising a SL-PRS CG identifier (ID) of the SL-PRS CG configuration and a periodicity of the SL-PRS CG configuration.

10. The method of claim 9, further comprising:
transmitting, to the UE, second DCI including first information indicating the SL-PRS CG configuration, and second information indicating activation or release of the SL-PRS CG configuration,
wherein a CG based periodic SL-PRS is transmitted based on the second DCI.

11. A user equipment (UE) in a wireless communication system, the UE comprising:
a transceiver; and
a controller coupled with the transceiver and configured to:
transmit, to a base station, sidelink UE information associated with the UE, wherein the sidelink UE information includes information for requesting a configuration of a resource for a sidelink positioning reference signal (SL-PRS),
receive, from the base station, configuration information associated with a resource pool for the SL-PRS,
transmit, to the base station, information for requesting a SL-PRS resource, based on the configuration information,
receive, from the base station, first downlink control information (DCI) scheduling the SL-PRS resource, and
transmit the SL-PRS on the SL-PRS resource based on the first DCI.

12. The UE of claim 11,
wherein the information for requesting the configuration of the resource includes a transmission resource request comprising a sidelink destination identity for the SL-PRS,
wherein the information for requesting the SL-PRS resource comprises a medium access control (MAC) control element (CE) including a destination index for the SL-PRS resource and information on a bandwidth for the SL-PRS resource, and
wherein the destination index corresponds to the sidelink destination identity.

13. The UE of claim 11,
wherein, in case that the resource pool for the SL-PRS is a shared resource pool:
the first DCI is used for scheduling of a physical sidelink control channel (PSCCH) and a physical sidelink shared channel (PSSCH), and
wherein, in case that the resource pool for the SL-PRS is a dedicated resource pool:
a SL-PRS resource of the resource pool is configured with a SL-PRS resource identifier (ID), a comb size of the SL-PRS resource, a comb offset of the SL-PRS resource, a number of symbols for the SL-PRS resource, and a symbol offset of the SL-PRS resource, and
the first DCI is used for scheduling of the SL-PRS, and includes information indicating the SL-PRS ID.

14. The UE of claim 11,
wherein, in case that the UE is configured to report configured grant assistance information, the controller is further configured to:
transmit, to the base station, UE information associated with the UE, the UE information including information on a periodicity and information on a bandwidth of a CG based SL-PRS transmission,
wherein the configuration information further includes a SL-PRS CG configuration for the CG based SL-PRS transmission comprising a SL-PRS CG identifier (ID) of the SL-PRS CG configuration and a periodicity of the SL-PRS CG configuration.

15. The UE of claim 14, wherein the controller is further configured to:
receive, from the base station, second DCI including first information indicating the SL-PRS CG configuration, and second information indicating activation or release of the SL-PRS CG configuration; and
transmit a CG based periodic SL-PRS based on the second DCI.

16. A base station in a wireless communication system, the base station comprising:
a transceiver; and
a controller coupled with the transceiver and configured to:
receive, from a user equipment (UE), sidelink UE information associated with the UE, wherein the sidelink UE information includes information for requesting a configuration of a resource for a sidelink positioning reference signal (SL-PRS),
transmit, to the UE, configuration information associated with a resource pool for the SL-PRS,
receive, from the UE, information for requesting a SL-PRS resource, based on the configuration information, and
transmit, to the UE, first downlink control information (DCI) scheduling the SL-PRS resource,
wherein the SL-PRS is transmitted on the SL-PRS resource based on the first DCI.

17. The base station of claim 16,
wherein the information for requesting the configuration of the resource includes a transmission resource request comprising a sidelink destination identity for the SL-PRS,
wherein the information for requesting the SL-PRS resource comprises a medium access control (MAC) control element (CE) including a destination index for the SL-PRS resource and information on a bandwidth for the SL-PRS resource, and
wherein the destination index corresponds to the sidelink destination identity.

18. The base station of claim 16,
wherein, in case that the resource pool for the SL-PRS is a shared resource pool:
the first DCI is used for scheduling of a physical sidelink control channel (PSCCH) and a physical sidelink shared channel (PSSCH), and
wherein, in case that the resource pool for the SL-PRS is a dedicated resource pool:
a SL-PRS resource of the resource pool is configured with a SL-PRS resource identifier (ID), a comb size of the SL-PRS resource, a comb offset of the SL-PRS resource, a number of symbols for the SL-PRS resource, and a symbol offset of the SL-PRS resource, and
the first DCI is used for scheduling of the SL-PRS, and includes information indicating the SL-PRS ID.

19. The base station of claim 16,
wherein, in case that the UE is configured to report configured grant assistance information, the controller is further configured to:
receive, from the UE, UE information associated with the UE, the UE information including information on a periodicity and information on a bandwidth of a CG based SL-PRS transmission, and
wherein the configuration information further includes a SL-PRS CG configuration for the CG based SL-PRS transmission comprising a SL-PRS CG identifier (ID) of the SL-PRS CG configuration and a periodicity of the SL-PRS CG configuration.

20. The base station of claim 19,
wherein the controller is further configured to:
transmit, to the UE, second DCI including first information indicating the SL-PRS CG configuration, and second information indicating activation or release of the SL-PRS CG configuration, and
wherein a CG based periodic SL-PRS is transmitted based on the second DCI.
